(19) United States
(12) Patent Application Publication
(10) Pub. No.: US 2015/0280628 A1
(43) Pub. Date: Oct. 1, 2015

(54) DIGITAL POWER PLANT

(71) Applicant: JOSEPH SAJAN JACOB, LAWRENCEVILLE, GA (US)

(72) Inventor: JOSEPH SAJAN JACOB, LAWRENCEVILLE, GA (US)

(21) Appl. No.: 14/537,214

(22) Filed: Nov. 10, 2014

Related U.S. Application Data
(60) Provisional application No. 61/901,900, filed on Nov. 8, 2013.
(60) Provisional application No. 61/902,387, filed on Nov. 11, 2013.
(60) Provisional application No. 61/902,889, filed on Nov. 12, 2013.
(60) Provisional application No. 61/903,001, filed on Nov. 12, 2013.

(51) Int. Cl. H02P 9/04; H02J 7/00; H02K 7/18

(52) U.S. Cl. CPC H02P 9/04; H02K 7/1892; H02J 7/0068

(57) ABSTRACT

A digital power plant system generally includes an electronic controller, a power source, a thermal electronic engine for converting a power source to rotational or linear motion, a demand-based starting and charging system that includes a capacitor bank and a battery bank, and a polyphase alternator. In use, the electronic controller monitors and engages the power source, engine, capacitors, batteries, and alternator. The electronic controller also learns the pattern of energy use and rearranges unpredictable energy sources into a predictable energy source. The engine does not have to be running to provide energy. The digital power plant is ultra-efficient and produces variable speed and variable frequency, and a digital system produces the desired output, independent of the speed of the generator. Thus, the digital power plant is an intelligent generator that supplies instantaneous and continuous power output in the most efficient way for both the engine and any power-consuming device.

### RELATED APPLICATIONS

This patent application claims priority to (1) U.S. Provisional Patent Application No. 61/903,001, entitled “Digital Power Plant,” filed Nov. 12, 2013, (2) U.S. Provisional Patent Application No. 61/902,387, entitled “Thermal Reaction Electronic Engine,” filed Nov. 11, 2013, (3) U.S. Provisional Patent Application No. 61/901,900, entitled “Demand-based Starting and Charging,” filed Nov. 8, 2013, and (4) U.S. Provisional Patent Application No. 61/902,889, entitled “Polyphase Alternator,” filed Nov. 12, 2013, each of which is hereby incorporated herein by reference its entirety, as if fully set forth herein.

### TECHNICAL FIELD

The present disclosure generally relates to systems and methods for electric generators, and more particularly relates to a digital power plant, and associated methods for controlling a digital power plant.

The present disclosure also generally relates to engines and associated methods for producing electricity, and more particularly relates to a thermal electronic engine and associated methods for controlling the thermal electronic engine.

Within the discussion of a digital power plant and a thermal electronic engine, the present disclosure further generally relates to systems and methods for controlling smart batteries, and more particularly relates to a capacitor bank and associated methods for demand-based starting and charging; and generally relates to a polyphase alternator, and more particularly relates to a polyphase alternator with coils that may be individually positively and negatively charged, and associated methods for controlling the polyphase alternator.

### BACKGROUND

Generators are commonly used to convert power sources into electricity. One purpose served by generators is to act as small- to mid-sized standby or “off-grid” sources of power. Such units may be portable or permanently placed, and either they provide electricity when another source goes down or they are the main source of electricity in a remote application.

Farms and locations in developing countries are examples of remote areas where a dependable, efficient generator can make a significant difference in quality of life. Although many generators run on gas, an ideal solution is for a generator to utilize whatever natural power source is available in the area of installation. Sources of energy that currently attract publicity include solar, wind, and bio-gas.

Each energy source brings its own strengths and weaknesses that impact the design of related generators. Solutions for one energy source do not always fit well with a different energy source. This challenge of adapting one unit to different energy sources creates complexity within the market for generators and also builds inherent inefficiencies into generators that try to utilize multiple energy sources to power one unit.

Current generators also leave room for improvement in the way they create and manage electricity. Generator engines tend to run hard, even if they are powering only one light bulb, and they do so whenever a call for power arrives. Such design is costly for the owners of the generators, who must service and replace the generators earlier than they should have to make additional investment into the product. This cost is particularly difficult on people in less affluent countries. There is need in the art for an efficient and affordable solution.

External Combustion Engine

External and internal combustion engines are well represented in the prior art. Early external combustion engines like the Sterling engine and the steam engine revolutionized the world. Then internal combustion engines spurred developments in mobility and efficiency.

For the most part, engines operate according to fixed parameters, often dictated by lengths of shafts and rotation of shafts. For example, the distance a shaft travels when it acts as a piston determines the displacement from one chamber into another. Fixed parameters typically aid efficiency for a particular end use.

However, efficiency may be gained in a different manner. By removing certain fixed parameters and bringing other forces to bear, and in conjunction with software to monitor and optimize movement, we are able to take a fresh approach to engine function. For example, varying thermal flow is one way to impact the movement of a piston, and the thermal component is well suited to an external combustion engine powered by natural means, such as solar power, natural gas, and bio-gas. There is need in the art for a thermal reaction electronic engine that marries external combustion with intelligent controls.

Starting and Charging

When a power-consuming device calls for electricity, such as the flipping of a light switch, the electricity typically flows immediately. The generator receiving the call for power comes to life, usually at full torque, and remains at full torque until the need for power ceases.

Capacitors are known to hold charges and act like batteries. Also, variable motors are known to operate at incremental speeds in order to provide efficiency and longer motor life. Yet greater efficiencies and advantages are available through improvements that may be made to capacitors and motors related to demand-based starting and charging.

There is need in the art for an electronically-controlled capacitor bank that exploits the synergies between generators and capacitors. To gain incremental efficiencies that add up to significant efficiencies, one must employ an electronic controller with sophisticated software that dictates instantaneous changes.

Polyphase Alternator

In conventional electric generators, a shaft is rotated to exert a magnetic force upon conductor coils located in the magnetic field, thereby conducting an electric current in the conductor coils. Alternators, generators that produce alternating current, are typically used to start engines. Alternators may be 1-, 2-, or 3-phase, the latter also referred to as polyphasic.

Prior art addresses several aspects of polyphase alternators. As examples, they may be designed with staggered arrays of coils used to reduce or cancel cogging as a rotor turns, and they may also be designed to reduce drag caused by magnetic attraction to metal components within an assembly (such as an iron core that holds a coil wire).

However, ample room remains for further refinements. Efficiencies may be gained through improved software, improved windings of conductor coils, improved use of materials comprising the alternator, and sophisticated interaction among all of those improved aspects.

There is need in the art for an ultra-efficient polyphase alternator that produces variable speed and variable frequency and that may be intelligently controlled through an electronic controller such that individual coils may be positively or negatively charged.

There is need in the art for a hybrid digital power plant—a generator that uses multiple energy sources, such as solar power and bio-gas, without need for modification and that uses intelligence to manage and learn the pattern of power use in order to run the engine intermittently and at partial speeds, while assuring instantaneous and continuous power output.

### SUMMARY

A digital power plant system generally includes an electronic controller, a power source, a thermal electronic engine, a demand-based starting and charging system that includes a capacitor bank and a battery bank, and a polyphase alternator. A power-consuming device benefits from the system and may be considered part of the system.

A thermal electronic engine for converting a source of power to rotational or linear motion, or eventually to electricity, generally includes a hot chamber that is heated by at least one external power source, a cold chamber connected to the hot chamber by a closed loop of tubes and valves that direct the flow of an inert or other special gas, a piston driven by temperature and gas, and an electronic controller. Certain configurations include magnets and compressed air that act upon the piston.

A system for demand-based starting and charging generally includes an electronic controller, a power source such as a generator, and a capacitor bank. The capacitor bank may work in tandem with a battery bank of rechargeable batteries. A powered device may or may not be considered part of the system.

A polyphase alternator generally includes an electronic controller, at least one permanent magnet assembly that may be a rotor, one or more winding arrays that may be stators, each containing an array of conductive coils, and a drive shaft. In use, the electronic controller causes the drive shaft to turn at least one rotor around one or more stators. The coils of the polyphase alternator may be individually positively or negatively charged in order to affect an engine, producing variable speed and variable frequency. A digital system produces the desired output, independent of the speed of the generator.

Other systems, devices, methods, features, and advantages of the disclosed digital power plant systems and methods for operating digital power plants, of the disclosed thermal electronic engine and related methods, of the disclosed systems and methods for demand-based starting and charging, and of the disclosed polyphase alternator and methods for controlling the polyphase alternator will be apparent or will become apparent to one with skill in the art upon examination of the following figures and detailed description. All such additional systems, devices, methods, features, and advantages are intended to be included within the description and to be protected by the accompanying claims.

### BRIEF DESCRIPTION OF THE DRAWINGS

The present disclosure may be better understood with reference to the following figures. Corresponding reference numerals designate corresponding parts throughout the figures, and components in the figures are not necessarily to scale.

It will be appreciated that the drawings are for illustrative purposes and that the invention is not limited to the illustrated embodiment. For clarity and in order to emphasize certain features, not all of the drawings depict all of the features that might be included with the depicted embodiment. The invention also encompasses embodiments that combine features illustrated in multiple different drawings; embodiments that omit, modify, or replace some of the features depicted; and embodiments that include features not illustrated in the drawings. Therefore, it should be understood that there is no restrictive one-to-one correspondence between any given embodiment of the invention and any of the drawings.

Also, many modifications may be made to adapt or modify a depicted embodiment without departing from the objective, spirit and scope of the present invention. Therefore, it should be understood that, unless otherwise specified, this invention is not to be limited to the specific details shown and described herein, and all such modifications are intended to be within the scope of the claims made herein.

FIG. 1 illustrates a simple electric generator system according to prior art.

FIG. 2 is a flow chart that illustrates a typical, simple prior art method for operating an electric generator.

FIG. 3 illustrates an embodiment of the digital power plant system according to the present invention.

FIG. 4 is a flow chart that illustrates a method of operating a digital power plant according to the system of FIG. 3.

FIG. 5 illustrates application of a compensatory charge curve by the system in response to predictive models of energy use and power source.

FIG. 6 is a cut-away view of an illustrative embodiment of prior art, an alpha type Sterling engine.

FIG. 7 is a cut-away view of an illustrative embodiment of a thermal electronic engine according to the present invention.

FIG. 8 illustrates the embodiment of FIG. 7 with the piston in motion.

FIG. 9 illustrates the thermal electronic engine of FIG. 7 in a linear, or inline, three-cylinder configuration with similar thermal electronic engines.

FIG. 10 is a front view of a V-shaped engine in which one cylinder consists of a cold chamber and a hot chamber.

FIG. 11 is a flow chart of a method for controlling a thermal electronic engine.

FIG. 12 is a cut-away view of an embodiment of a cold chamber of a thermal electronic engine with magnets.

FIG. 13 is the embodiment of FIG. 12 with the piston in an extended position.

FIG. 14 is a compressed air chart that illustrates the effect of compressed air on a magnetized piston.

FIG. 15 is a flow chart of the method for controlling a thermal electronic engine of FIG. 11 with the inclusion of magnets and compressed air.

FIG. 16 illustrates one embodiment of a demand-based starting and charging system according to the present invention.

FIG. 17 is an illustrative embodiment of the charge and discharge curves of at least two supercapacitors layered in a capacitor bank.

FIG. 18 illustrates a typical supercapacitor charging curve with use of controlled spikes.

FIG. 19 illustrates the stages of recharging a battery bank.

FIG. 20 is a flow chart of a method for demand-based starting and charging.

FIG. 21 is a front view of a winding array having eight equally spaced apart conductive coils.

FIG. 22 is an illustrative front view of a winding core with bifilar wiring.

FIG. 23 is an illustrative side view a set of three winding arrays. Only the front face of the “nearest” core tops are shown, relative to the shaft and offset from one another.

FIG. 24 is a front view of a set of three winding arrays, such as the winding array of FIG. 21, radially offset relative to one another as in FIG. 23.

FIG. 25 is a front view of a permanent magnet assembly.

FIG. 26 is a perspective view of the permanent magnet assembly of FIG. 25.

FIG. 27 is a front view of a set of three winding arrays within a permanent magnet assembly.

FIG. 28 is an illustration of a polyphase alternator's starting and charging curves.

FIG. 29 is a flow chart illustration of a method of controlling a polyphase alternator of the present invention.

### DETAILED DESCRIPTION

Described below are embodiments and configurations of digital power plant systems and methods for operating digital power plants. Such systems and methods may comprise an electronic controller, a power source, a thermal electronic engine, a capacitor bank, a battery bank, and a polyphase alternator. A power-consuming device benefits from the system and may be considered part of the system. In use, the electronic controller monitors and engages the power source, engine, capacitors, batteries, and alternator. The electronic controller also learns the pattern of energy use by the power-consuming device and rearranges unpredictable energy sources into a predictable energy source. The engine does not have to be running to provide energy. Thus, the digital power plant is an intelligent generator that supplies instantaneous and continuous power output in the most efficient way for both the engine and the power-consuming device. Many different embodiments and configurations are contemplated.

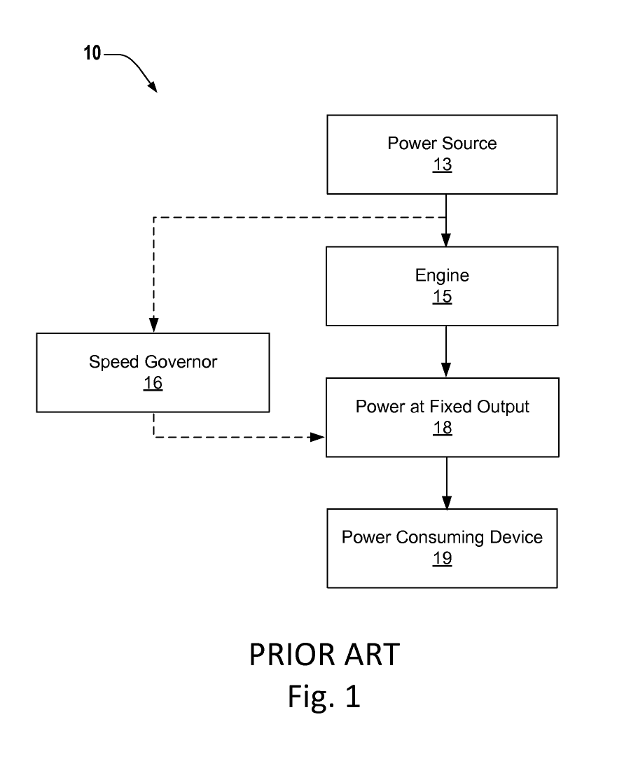

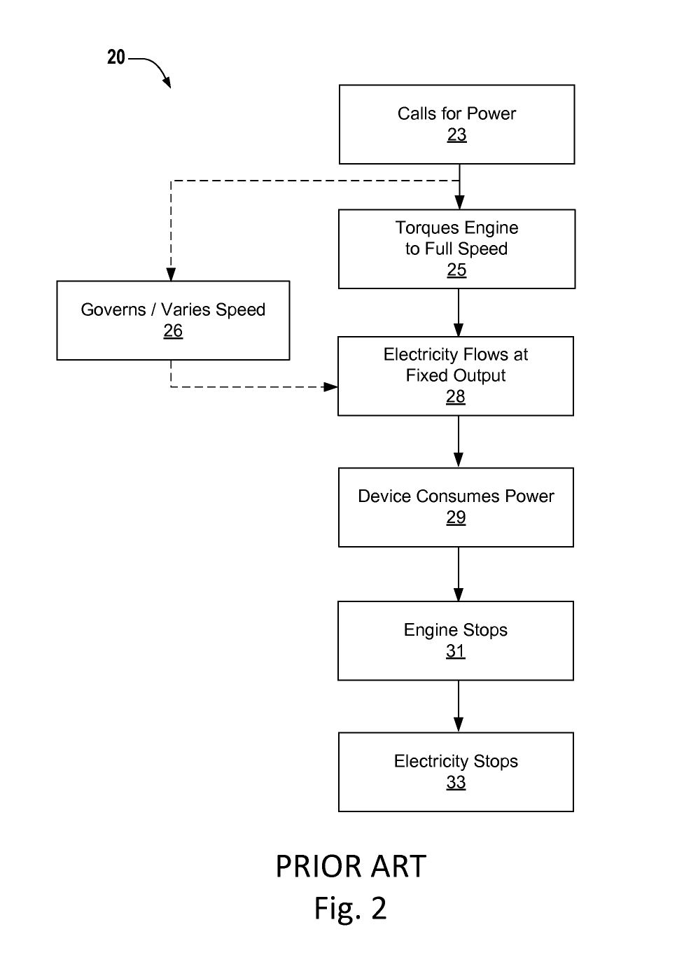

FIGS. 1 and 2 are simplified illustrations of a common prior art electric generator system 10 and its method of generating electricity 20. An external power 13 source feeds an engine 15 that in turn produces power 18, or electricity 18, to be consumed by a device 19 or devices. When a power-consuming device 19 calls for power 23, the engine 15 kicks in, torques to full speed 25, and runs at the speed for which the engine 15 was optimized when designed. The device consumes power 29. When there is no need for power 18, the engine turns off 31, and the power stops 33. At the next call for power 23, the system 10 will repeat the process 20. A speed governor 16 may allow a motor or engine 15 to produce variable speeds 26 that may bring increased efficiency to an electric generator system 10, but such an arrangement will produce variable outputs.

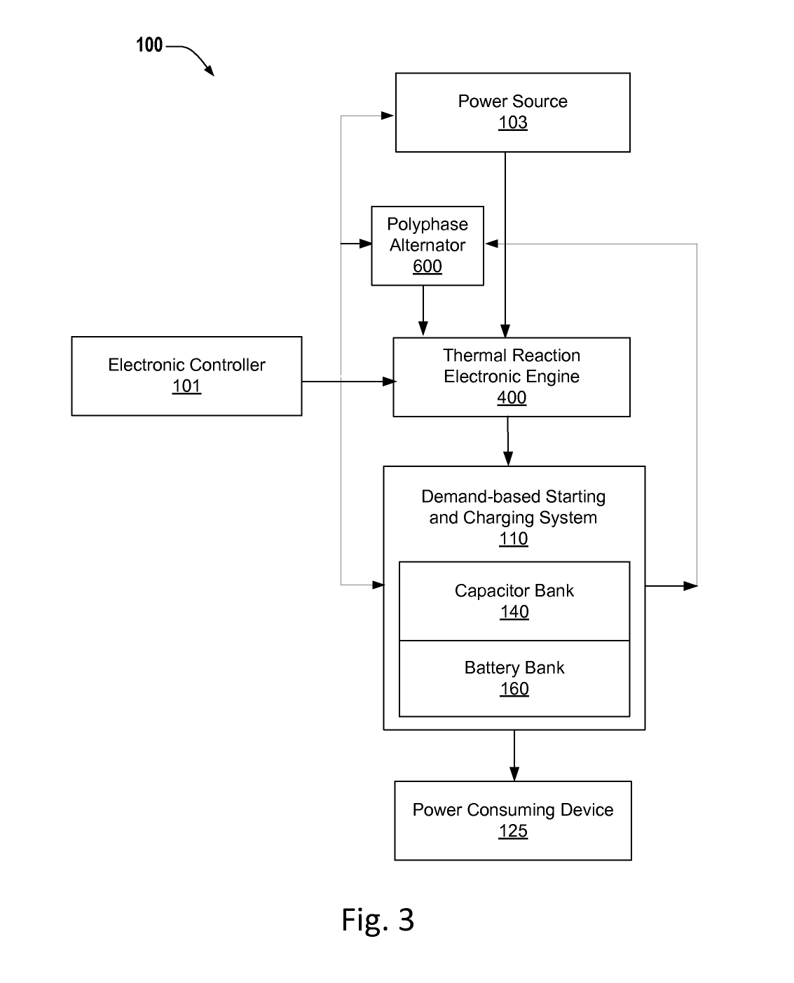

FIG. 3 illustrates a preferred embodiment of the digital power plant 100 according to the present invention. An electronic controller 101 interfaces with key components throughout the system 100 such that the components work in harmony. Each of the key components by itself is an intelligent device or system, and the combined systems realize synergy of intelligence. The electronic controller 100 contains proprietary software that utilizes artificial intelligence to monitor the system 100 and conduct preventive maintenance. An electronic controller 100 may be a digital controller 100. An electronic controller 100 may be a printed circuit board (“PCB”), a computer, or another suitable structure that includes circuitry and logic for executing control functions.

The power source 103 is an external fuel or energy that generates heat. Power sources 103 include, but are not limited to, liquid and gaseous fuels (NG, LP, process and/or raw bio-gas) and solar power. Use of an external combustion engine 400 in this system 100 allows for multiple power sources 103 to be fed to the engine 400 without changeover; therefore, the power source 103 may be a hybrid or multi-power source 103.

The thermal electronic engine 400 will be described more fully later in this application. A thermal electronic engine 400 generally includes a hot chamber 440 that is heated by at least one external power source 103, a cold chamber 460 connected to the hot chamber 440 by a closed loop of tubes 434 and valves 432 that direct the flow of a gas 430, a piston 410 driven by temperature and gas 430, and an electronic controller 490. Certain configurations include a magnet controller 494 and a compressed air controller 496 that influence the piston 410.

A demand-based starting and charging system 110 is more fully described later in this application. A system for demand-based starting and charging 110 generally includes an electronic controller 111, a power source such as a generator 120, a capacitor bank 140, and a battery bank 160. The capacitor bank 140 generally includes two or more supercapacitors 142 that can charge and discharge at the same time, and also charge and discharge at different rates 145. The capacitor bank 140 serves two purposes at an initial call for power. First, the electronic controller 111 discharges current 242 from the capacitor bank 140 to meet the need of the power-consuming device 125. Simultaneously, the electronic controller 111 discharges current from the capacitor bank 140 to start the generator 120/400 utilizing an alternator 600. The capacitor bank 140 may be considered a fast-charging battery in which each cell is a capacitor 142 or battery. A battery bank 160 comprised of slow-charging batteries 162 may work in conjunction with the capacitor bank 140. These batteries 142 may be NiCd, NiCd/Lithium Ion or any other type of battery 142 suited for the purpose. Intelligent charging is required to manage the give-and-take of fast and slow charging, as well as the variation in charge rates. The electronic controller 111 selectively charges and discharges batteries 162 and supercapacitors 142 at various charge curves and discharge curves 145 and introduces charging voltage spikes 158 or pulses on specific phases. Spontaneous charging ensures uninterrupted power without continuous alternator 600 operation, and the charge and discharge curves 145 are predictable and controllable. The digital power plant system 100 is not limited to capacitor bank 140, battery bank 160, or a demand-based starting and charging system 110 of this particular design.

A polyphase alternator 600 is more fully described later in this application. The polyphase alternator 600 not only acts like a supercapacitor to start the thermal electronic engine 400 and eliminate cogging, but it functions as a generator itself. The coils 640 of the polyphase alternator 600 may be individually positively or negatively charged in order to affect the engine 400. Thus, the polyphase alternator 600 is ultra-efficient and produces variable speed and variable frequency 810. The polyphase alternator 600 is a reliable design that is difficult to damage electrically. The digital power plant system 100 is not limited to an alternator 600 or starter of this particular design. The polyphase alternator 600 typically receives its charge from the capacitor bank 140, but the polyphase alternator 600 may receive its charge from elsewhere in a different configuration.

The power-consuming device 125 may be anything or things expected to draw electricity from the digital power plant 100. The digital power plant 100 is a system with or without the power-consuming device 125.

FIG. 3 is a simplified drawing, and many details of the power plant 100 have been omitted for clarity. The components may be connected to one another in ways other than as shown, and components may be omitted or substituted within a functioning digital power plant system 100. It is envisioned that the digital power plant 100 will be compact, yet the digital power plant 100 may be scaled according to end use.

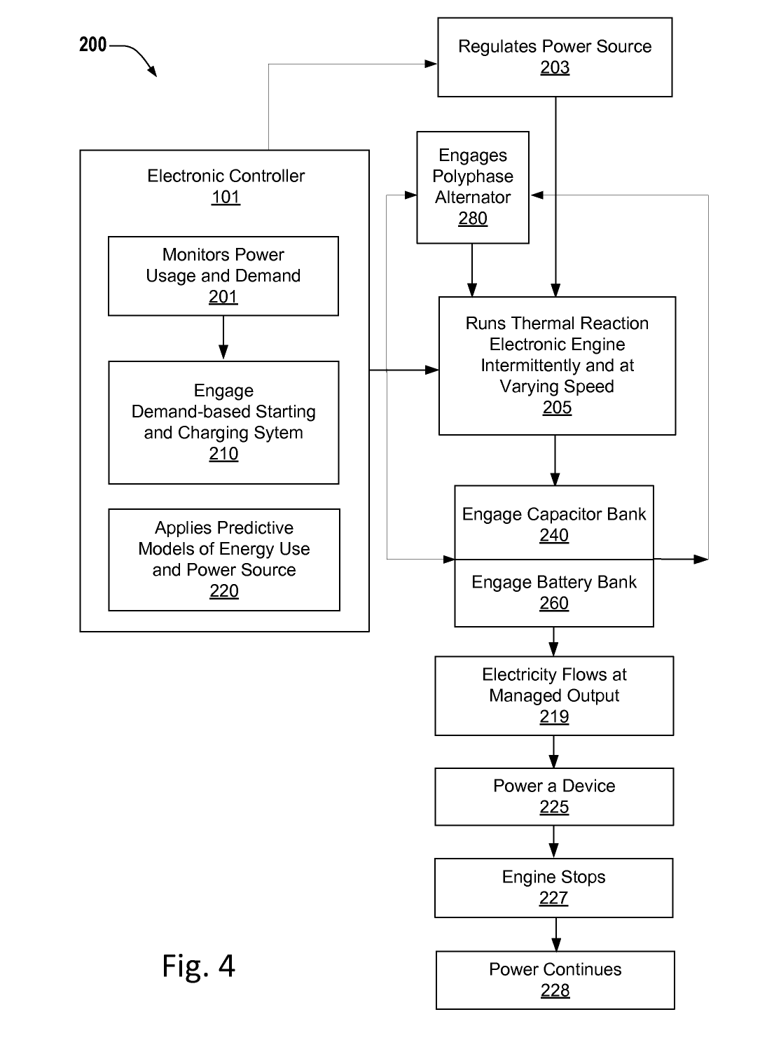

FIG. 4 is a flow chart that illustrates a preferred embodiment of the method of operating a digital power plant 200 according to the system 100 of FIG. 3. In use, the digital power plant 100 is placed convenient to both at least one power source 103 and at least one power-consuming device 125. An electronic controller 101 monitors power usage and demand 201. When power is needed, an electronic controller 101 engages and manages a demand-based starting and charging system 210 and regulates the power source 203. For example, at night the software of the electronic controller 101 might decide to engage the capacitor bank 240 and send a voltage spike 158 using supercapacitors 142 and reduce the use of natural gas 103. Then during the day the controller 101 might decide to run the engine 205 at low speed using only solar heat 103, no natural gas 103, while engaging the battery bank 260 and capacitor bank 240 and slowly charging the batteries 162 or capacitors 142, respectively.

Typically an electronic controller 101 discharges one or more supercapacitors 142 in the capacitor bank 240 and/or batteries 162 in the battery bank 260 such that electricity flows at a managed output 219, so that a device may consume the power 225. An electronic controller 101 may also discharge one or more capacitors 142 in the capacitor bank 240 to engage a polyphase alternator 280 to start a thermal electronic engine 400. At least one power source 103 fuels the engine 400, and an electronic controller 101 and a polyphase alternator 600 run a thermal electronic engine intermittently and at varying speed 205 to produce electricity 219 and to charge the demand-based starting and charging system 110. A digital system 101 is employed to produce the desired output 219 independent of the speed of the engine 400. Additionally, the mechanical speed of the thermal electronic engine 400 may be altered electronically 520 to produce high voltage pulses 158 on select phases to instantaneously charge the capacitor bank 140 and to charge the polyphase alternator 600. The engine 400 may stop 227, yet the generator 100 will still provide power 228. Over time, the artificial intelligence of an electronic controller 101 learns how the system is being used, the pattern of power use, and refines its control of the system 220. In FIG. 4, some of the steps are optional, and the order of the steps may in many instances be re-arranged.

Current industry practice is to depend upon the engine 15 motion to directly provide energy 18 to match a power demand curve. The engine 15 runs as long as power is demanded 29. A digital power plant 100, on the other hand, captures DC and converts to AC. Power production and output is not directly linked to engine 400 rotation, but to stored energy. A digital power plant 100 will still provide power 228 with the engine 400 at zero speed (zero rotation). When the engine 400 does run, the electronic controller 101 targets optimum RPM as part of a predictive system 220 rather than a simple ramp-up 25 to meet calls for power 23.

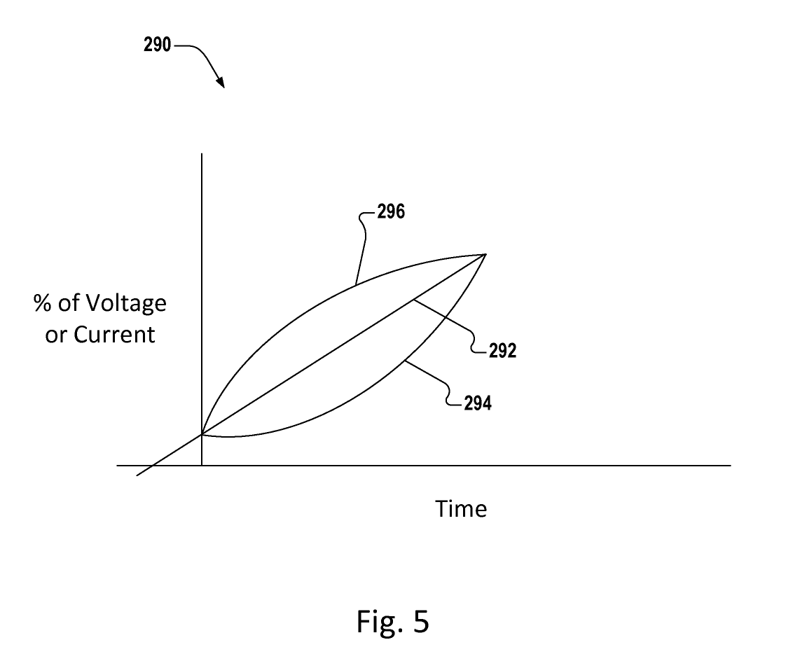

FIG. 5 illustrates application of a controlling or compensatory charge curve by the system 290 in response to predictive models of energy use and power source 220. The predictive system makes use of proportional integral derivative (PID) control algorithms. Specifically, the electronic controller 101 maps the actual charging curve 294, also referred to as the actual energy path or output 294, versus a target or ideal load curve 292, also referred to as wanted energy output 292. Then the controller 101 uses available sources of information, including patterns of previous power usage and unpredictable weather forecasts, to project a remedy 296 that will bring actual energy output 294 in line with the target energy output 292. Unpredictable energy sources 103 are patterned into a predictable energy source 220 using learn-and-act principles. This resultant predictable pattern is used to meet the output requirements 219 using a PID function 294 and its inverse 296. The corrective input or remedy 296, which is the anticipated compensatory charge curve 296, is the inverse 296 of the actual charging curve 294, and this predictive input is iterative in nature 220, calculated and applied on an ongoing basis. Predictive technology may be applied at the level of each component within the digital power plant 100 that is overseen by an electronic controller as well as by the main electronic controller 101 that runs the digital power plant 100.

Thermal Reaction Electronic Engine (TREE)

Described below are embodiments and configurations of a thermal reaction electronic engine (TREE) and associated methods for controlling a thermal electronic engine. Such engine and methods may comprise a hot chamber that is heated by at least one external power source, a cold chamber connected to the hot chamber by a closed loop of tubes and valves that direct the flow of an inert or other special gas, a piston driven by temperature and gas, and an electronic controller. Certain configurations include magnets and compressed air that act upon the piston. In use, the electronic controller regulates the flow of at least one external power source and adjusts the thermal flow of gas through and between a hot chamber and a cold chamber. The electronic controller monitors the piston position and decides which valves to activate in order to circulate gas among chambers. Accordingly, the electronic controller dictates the speed of the piston and the distance it moves, thereby regulating output.

Many different embodiments and configurations are contemplated. Other embodiments include a combination and/or selection of some of, but not all of, the following features. Magnets and electromagnets acting upon the piston allow the electronic controller to boost the speed of the piston. Compressed air may act upon the system in three ways: airflow acts on the cold chamber creating a pressure difference and additional pull on the piston, airflow lends a negative temperature, and/or airflow engages the piston with a push and torque effect. A digital encoder measures the absolute position of the piston.

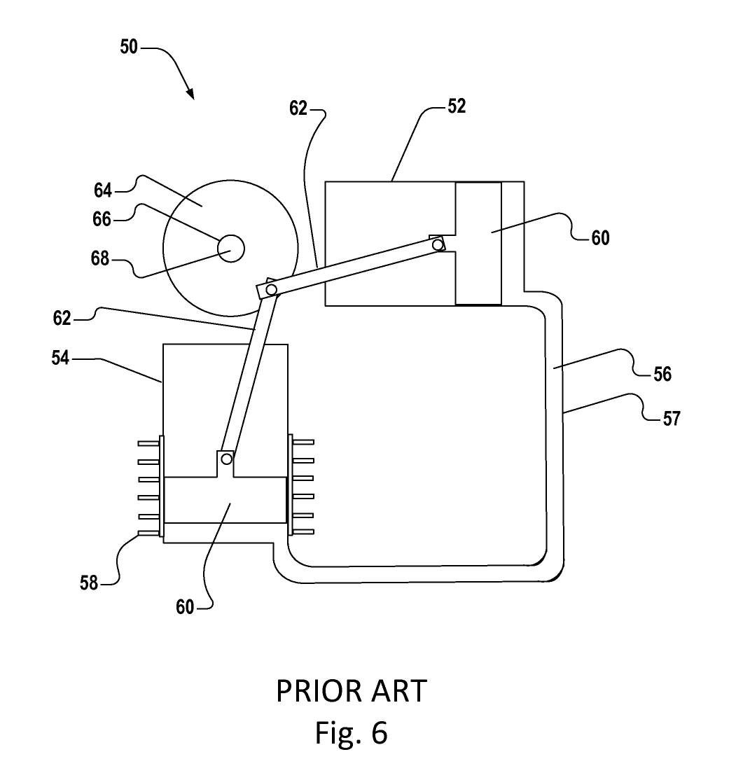

FIG. 6 is a cut-away view of an illustrative embodiment of prior art, an alpha type Sterling engine 50. Gas 56 is heated in an expansion cylinder 52 and cooled in a compression cylinder 54 via a heat exchanger 58, also called a regenerator 58. The gas 56 travels between the two cylinders 52 and 54 through a tube or pipe 57 in a closed cycle. The flow of gas 56 causes the piston heads 60 to move, pushing and pulling the rotably coupled, fixed shafts 62 in a cyclical motion. Thus, the shafts 62 turn a flywheel 64 that is mounted to a driveshaft 68 through an aperture 66 in the flywheel's 64 center. A net conversion of heat energy to mechanical work is realized by compression and expansion of a gas 56 that is a working fluid.

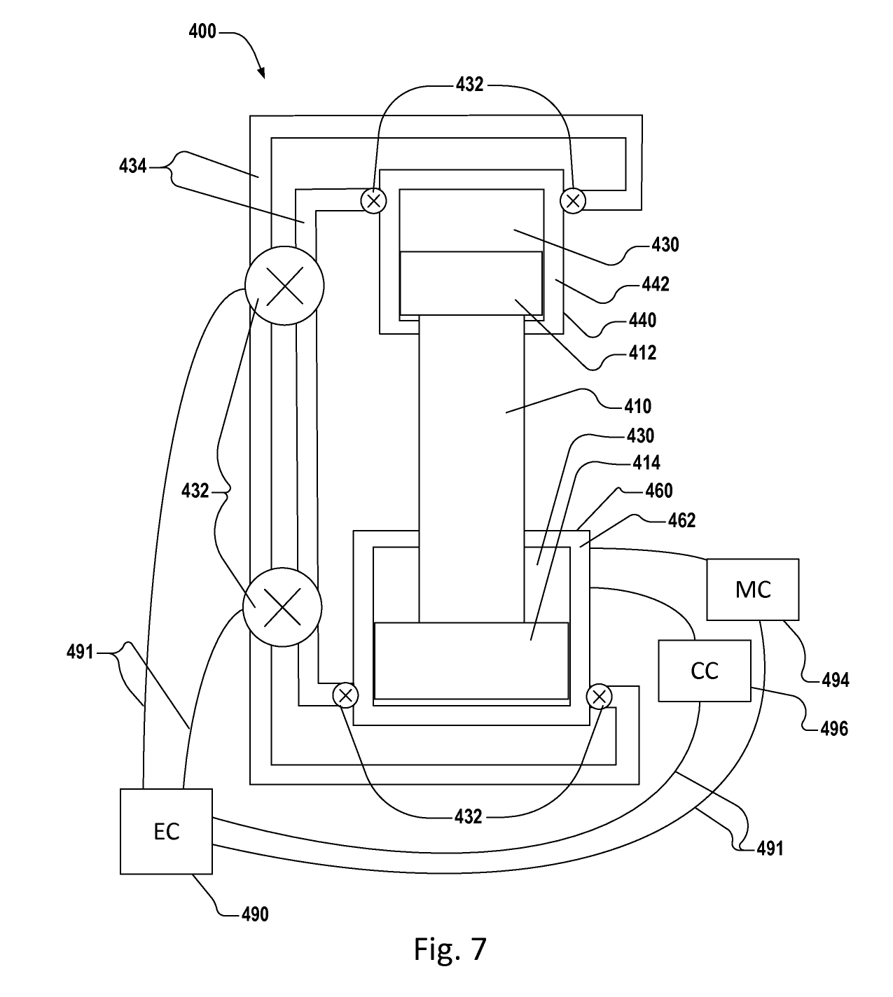

FIG. 7 is a cut-away view of an illustrative embodiment of a thermal electronic engine 400 in which a piston 410 is positioned to move within and between a hot chamber 440 and a cold chamber 460. The cold chamber 460 is larger than the hot chamber 440. The chambers 440 and 460 are sized based upon the needs of a particular engine 400, and the piston 410 is sized accordingly. The piston heads 412 and 414 fit within the chamber walls 442 and 462, respectively, such that the piston 410 displaces the gas 430 in the chambers 440 and 460 without gas 430 seeping around the piston heads 412 and 414, yet the piston 410 moves smoothly.

The piston 410 and chamber casings 442 and 462 are constructed of materials that withstand the temperatures and pressures of engine 400 operation. Materials include, but are not limited to plastic composites and metal alloys, including steel and aluminum.

The hot chamber 440 and the cold chamber 460 each contain at least one valve 432, with tubing 434 connecting the valves 432 and chambers 440 and 460 in a closed loop. The closed loop contains an inert or other special gas 430 that may be heated, cooled, and circulated. The gas 430 may be argon or any other inert gas, or a gas 430 specially composed for this use. Valves 432 and tubing 434 also are constructed of materials that withstand the temperatures and pressures of engine 400 operation, including plastic composites and metals. Valves 432 may be nozzles and may have an aperture or apertures (not shown) of any size needed for the specified use. It is envisioned that the valves 432 are high-frequency valves 432 that pulse rapidly. These valves 432 may be referred to as high-speed valves 432, and they may be piezo-electric valves 432.

In a preferred embodiment, the hot chamber 440 contains two valves 432 and the cold chamber 460 contains two valves 432. Each valve 432 is connected to the two valves 432 of the opposing chamber 440 or 460, such that all valves 432 are cross-connected to enable full manipulation of thermal flow. One line of tubing 434 typically carries the hot source, and another line of tubing 434 typically carries the cold source. Opening and closing the valves 432 via electronic switching allows heated or cooled gas 430 to move within the closed loop and the two chambers 440 and 460. An electronic controller 490 is attached by wires 491 to the valves 432, as well as to a magnet controller 494 and to a compressed air controller 496, as discussed later. Alternatively, the electronic controller 490 may communicate wirelessly. Electronic switching makes this engine 400 a better and more controlled device than a comparable mechanical device 50. An electronic controller 490 may be a printed circuit board (“PCB”), a computer, or another suitable structure that includes circuitry and logic for executing control functions.

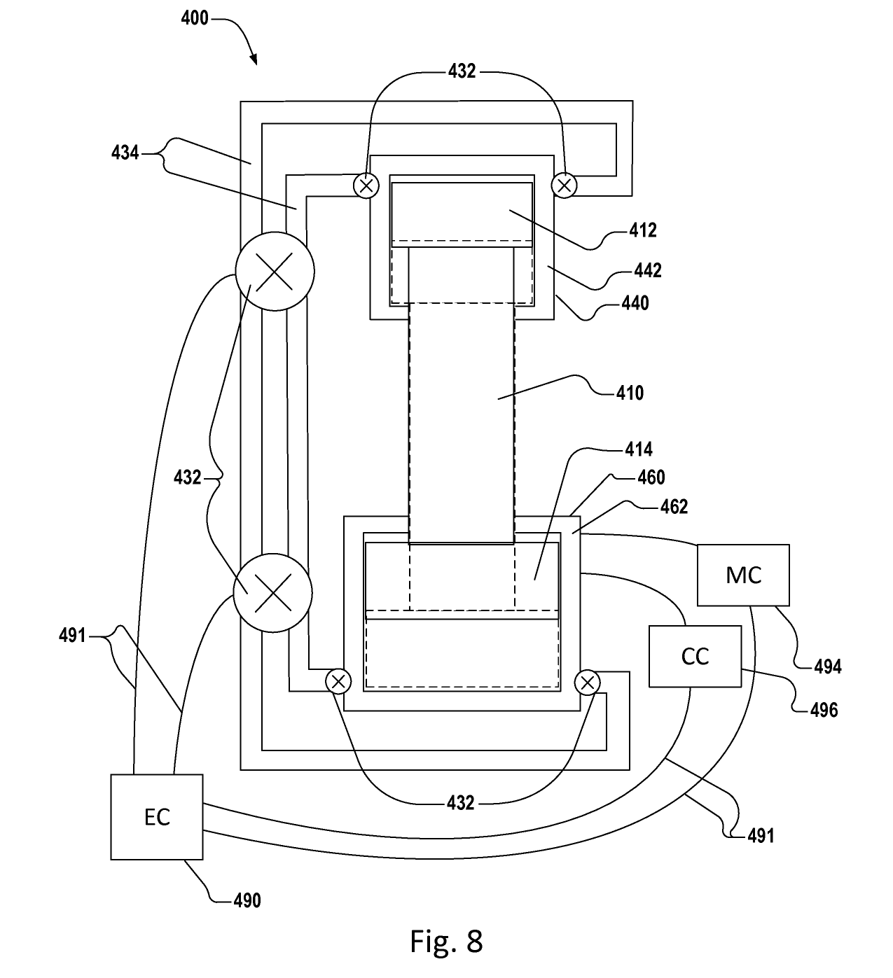

FIG. 8 shows the illustrative embodiment of FIG. 7 after the piston 410 changes position due to changes in temperature and pressure of the gas 430 in the closed loop system. There is no exhaust from the chambers 440 and 460.

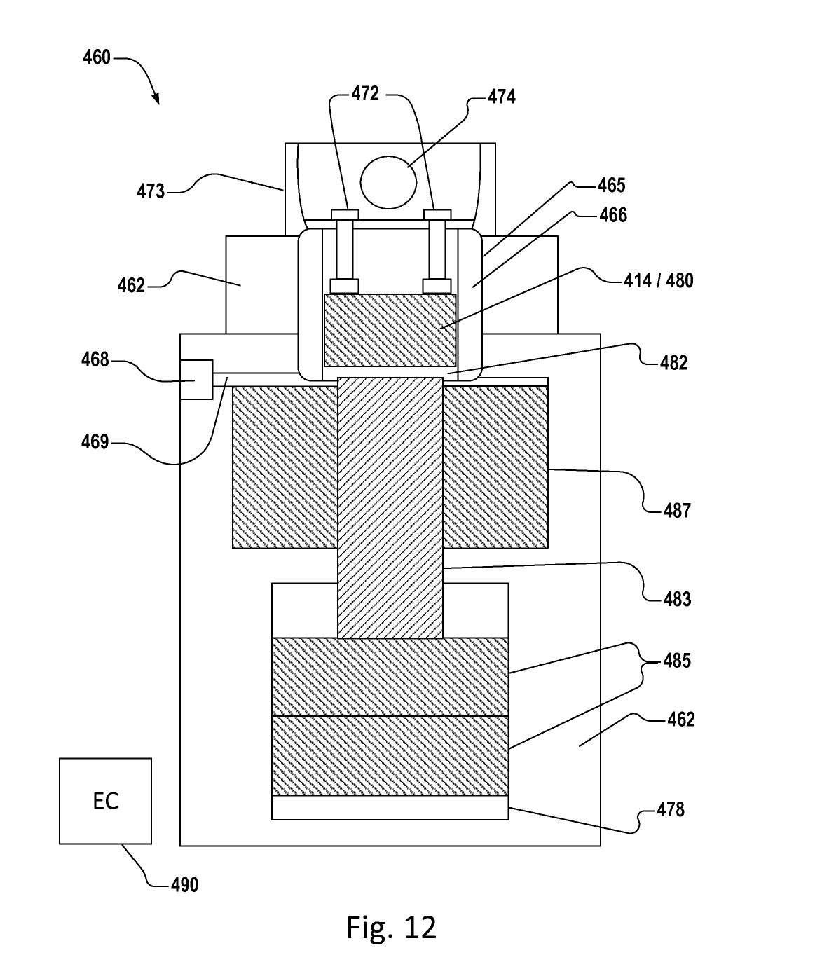

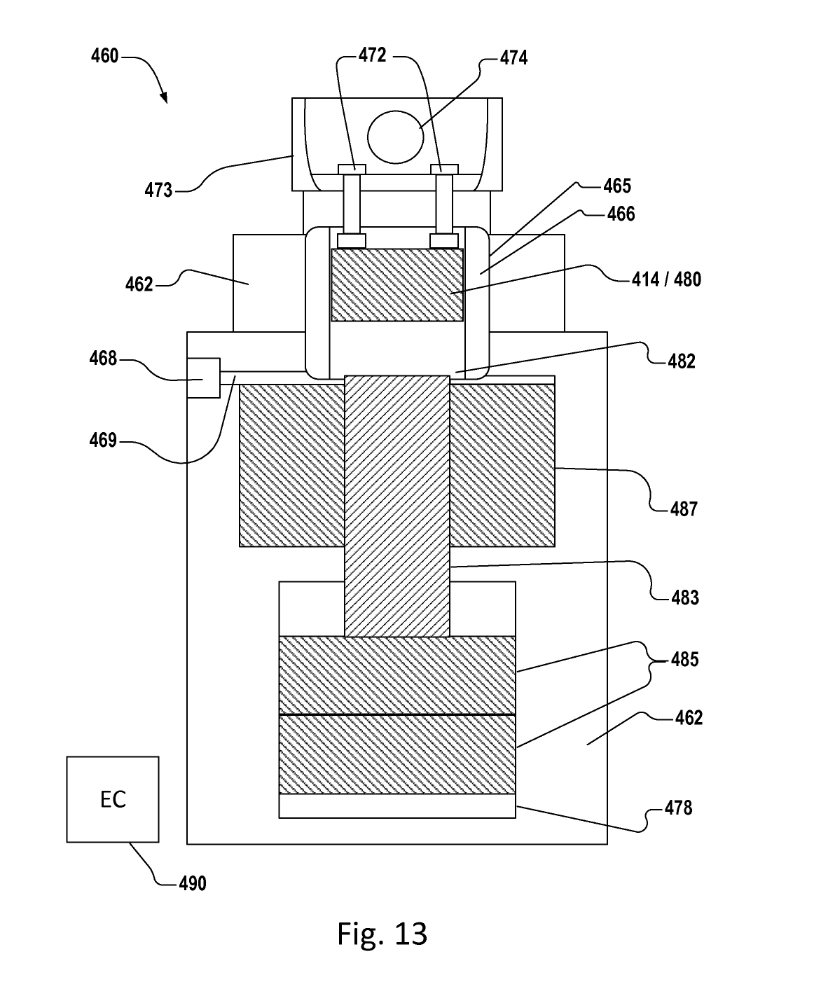

An electronic controller 490 engages at least one outside power source 103 (not shown) that produces heat. The heat from the outside power source 103 heats the gas 430 in the closed loop system. Heating takes place in the hot chamber 440, which may be called the expansion chamber 440. Alternatively, the expansion chamber 440 may be a chamber (not shown) internal to the hot chamber 440. Likewise, cooling takes place in the cold chamber 460, which may be called the contraction chamber 460. Alternatively, the contraction chamber 460 may be a chamber 465 (shown in FIGS. 12 and 13) internal to the cold chamber 460. The electronic controller 490 reads the position and speed 510 of the piston 410 and opens and closes valves 532 to regulate the flow of gas 505, thus dictating the position and speed of the piston 410. The system as described creates a push-pull or expansion-contraction relationship on the piston 410, and we may refer to the thermal flow as heat pushing and cold pulling.

Current industry practice focuses on the use of internal combustion engines and engines with fixed shaft 62 or stroke distance, the direction and results of their engine rotation not easily influenced or changed. The present invention is an electronic external combustion engine 400 that allows substantial influence on engine 400 operation and input of a variety of power sources that are beneficial to the environment, such as solar power, and to the economic wellbeing of the engine 400 owners, such as remotely located farmers who burn manure for energy. The thermal electronic engine 400 may be a multi-fuel device. Electronic control of the present invention further enhances benefits to the environment and the engine 400 owners by allowing variation of energy production to match the form of energy source and the pattern of energy use. Thus, the thermal electronic engine 400 is an intelligent and adaptive device. Further, the electronic controller 490 employs a learn-and-act algorithm to create predictive models from unpredictable events such as weather patterns.

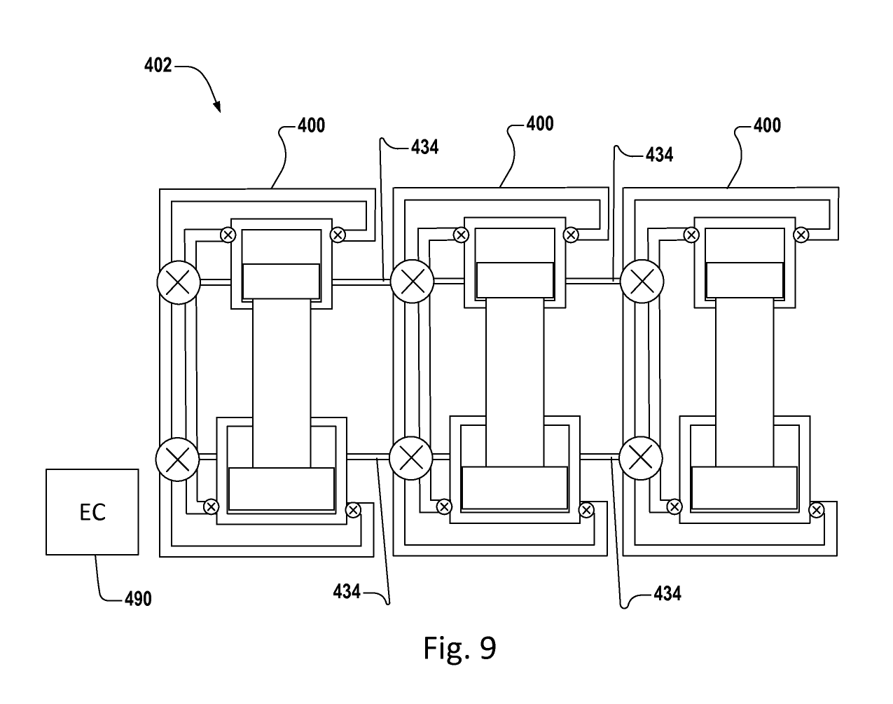

FIG. 9 illustrates the thermal electronic engine 400 of FIG. 7 in a linear, or inline, configuration 402. The engine of FIG. 7 is one cylinder 400, and three cylinders 400 inline with a closed loop of tubes 434 and valves 432 results in a larger thermal electronic engine 402. Any number of cylinders or engines 400 may be used, and the cylinders or engines 400 may be deployed in any of the many orientations possible to build a variant of the thermal electronic engine 400. Other cylinder 400 orientations include, but are not limited to, radial (rotary or circular) and V-shaped.

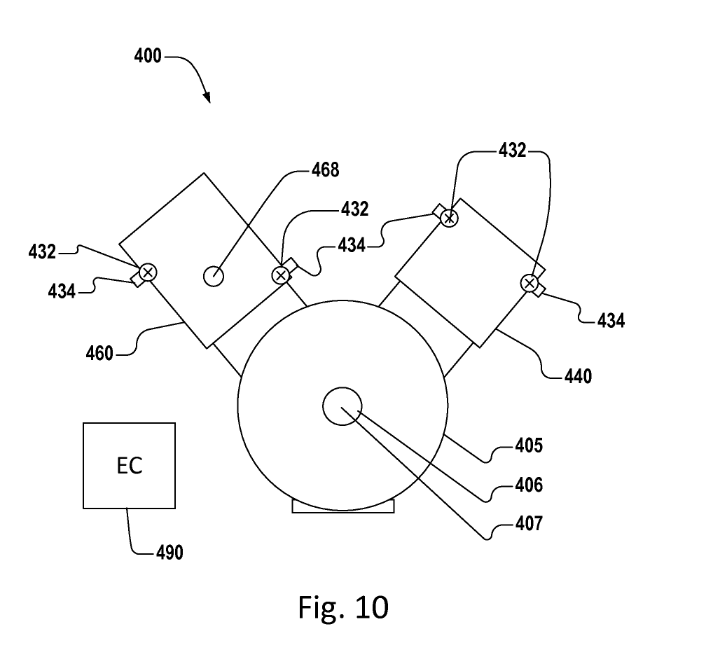

FIG. 10 illustrates a standard crankcase 405 with a V-shaped thermal electronic cylinder assembly 400. The cold chamber 460 and the hot chamber 440 together comprise the one cylinder assembly 400 mounted on top. Two such V-shaped cylinders 400 mounted atop the crankcase 405 would equal a two-cylinder V engine 400. The piston 410 may be attached to a standard crankshaft 407, or the crankcase 405 may contain a different mechanism (not shown) that allows the thermal electronic engine 400 to convert thermal energy into electricity. In an alternative embodiment, the thermal electronic engine 400 of FIG. 7 is equal to one engine cylinder 400, the one cylinder 400 comprising a hot chamber 440 and a cold chamber 460. Thus, FIGS. 7 and 10 may represent both a thermal electronic cylinder 400 and a thermal electronic engine 400.

Ports 468 are provided in the cold chamber 460 to allow compressed air 475 or 445 to circulate, but the compressed air 475 or 445 is not allowed to mix with the inert or other special gas 430, which is in a closed loop. Transfer of gas 430 through the expansion chamber 440 and contraction chamber 465 (shown later), the latter located within the cold chamber 460, cools the contraction chamber 465 and pulls the piston 410. The compressed air 475 or 445 provides a two-pronged boost. First, the compressed airflow 475 or 445 creates a pressure difference, pulling the piston 410. Second, the compressed air 475 or 445 may be employed to add push and torque to the piston 410. A byproduct of the compressed airflow 475 or 445 is negative temperature. The number and locations of ports 468 for compressed air 475 or 445 may vary according to the application for the engine 400.

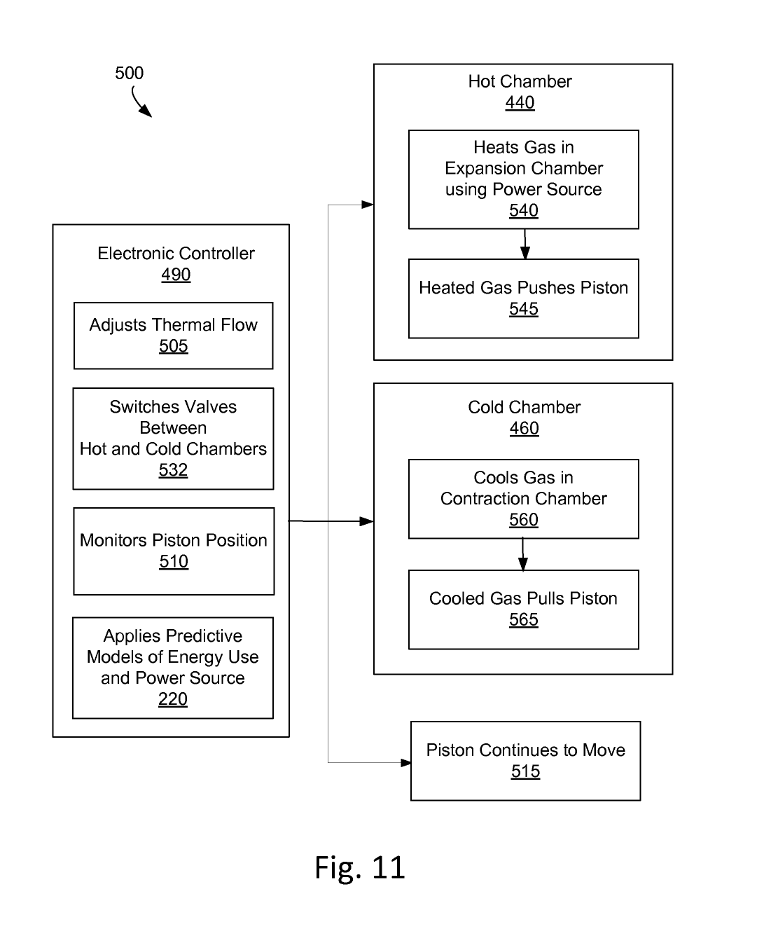

FIG. 11 is a flow chart that shows a method for controlling a thermal reaction electronic engine 500. The electronic controller 490 adjusts the thermal flow 505 throughout the whole engine 400 and monitors the position of the piston 510 as part of the process. The controller 490 heats the gas in the expansion chamber 540 of the hot chamber 440 using at least one outside power source 103 (not shown), cools the inert gas in the contraction chamber 560 of the cold chamber 460, and switches valves 532 to allow the gas 430 to flow among the chambers 440 and 460 in the most efficient manner. In this way, the electronic controller 490 displaces the piston 410 in one direction and then the other. Heated gas pushes the piston 545, and cooled gas pulls the piston 565. The piston continues to move 515 as the process repeats at variable or constant speed. The electronic controller 490 applies predictive models of energy use and of the power source 220 in order to learn and optimize engine 400 performance. In FIG. 11, some of the steps are optional, and the order of the steps may in many instances be re-arranged. Water or other means of cooling may also be employed.

The absolute position of linear and rotary motions in the thermal electronic engine 400 is monitored 510 by a digital encoding system, referred to herein as an encoder or angle encoder (not shown).

FIG. 12 is a cut-away view of an embodiment of a cold chamber 460 of a thermal electronic engine 400, such as the cold chamber 460 in FIG. 10. The internal chamber 465 with the smaller magnetized piston 414/480 is the contraction chamber 465 that is part of the closed loop containing inert or other special gas 430. Running lengthwise through the center of the cold chamber 460 is the fixed magnetic core 483. On one side of the core 483 is the movable piston magnet 414/480, but the movable magnet 480 and magnetic core 483 do not touch. On the other side of the magnetic core 483, in another internal chamber 478 that is separated from the closed gas loop, are two standard magnets 485. The mounting portion 473 of the cold chamber 460, including the assembly bolted 472 to the piston magnet 480, may be attached to a crankshaft 407 (not shown).

Four magnets 480, 487, and 485 are positioned within the cold chamber 460, in part to preserve them, as heat will destroy them. One magnet is an electromagnet 487, and three magnets are strong, permanent magnets 480 and 485. In a preferred embodiment, the four magnets 480, 487, and 485 are parallel to each other, such that there are two outer magnets 480 and 485a and two inner magnets 487 and 485b. One of the outer magnets acts as a piston end 480/144 within the contraction chamber 465. The electromagnet 487 is one of the inner magnets. At equilibrium, the strength of the piston magnet 480/414 in the contraction chamber 465 equals the additive strength of the other three magnets 487 and 485, such that the piston magnet 480 does not move. The equilibrium relationship among magnets is represented by the equation:

M₁+M₂₊E=M₃

Where:

M₁=Permanent Magnet 1(485a)

M₂=Permanent Magnet 2(485b)

E=Electromagnet 487

M₃=Moving Permanent Magnet 480 (in contraction chamber 465)

In use, an electronic controller 490 varies the strength and direction of the electromagnet 487, attracting and repelling the movable piston magnet 480 at high speed. A change in E 487 in the positive direction pushes M₃ 480 away from E 487. When E 487 counters to balance M₁+M₂ 485, then the magnetic pull is neutral. A change in E 487 in the negative direction attracts M₃ 480 to E 487. A gap 482 must always be maintained between the electromagnet 487 and the movable piston magnet 480 in order to maintain its mobility. The gap 482 is calculated based on the electromagnetic flux and not on the external reaction. Thus, the motion of the piston magnet 480 boosts the output of the thermal electronic engine 400 by approximately 25% or more. FIG. 13 is the embodiment of FIG. 12 with the piston head 480/414 in an extended position.

One of ordinary skill in the art will understand that the thermal electronic engine 400 is not limited to use of a fixed magnetic core 483 or to use of four magnets 480, 487, and 485 in parallel arrangement, but may use any number of magnets in any arrangement that achieves the desired outcome of managing piston 410 speed via controlling an electromagnet 487 in relation to other magnets. The other magnets may also be electromagnets, and the engine 400 is not limited to one electromagnet 487. Placement of an outside magnet 480 or magnets 480 and 485 is not limited to the head 414 of the piston 410. Magnets 480, 487, and 485 may be of any strength required and may be composed of any functional material, including, but not limited to, neodymium, neodymium alloys, and graphite alloys. The method of magnetization determines the angle of magnetization and biasing, both of which are critical to proper function. Such permanent magnets 480, 483, 485 or electromagnets 487 are extremely strong and dangerous and necessitate careful handling.

One of ordinary skill in the art will also understand that simplified drawings described in this specification speak to the key aspects of the invention and omit supporting elements, including but not limited to bolts, bushings, and wires.

One configuration of magnets 480, 487, and 485 not shown is one that exploits association with compressed airflow 475 or 445, which may be introduced through one or more ports 468 and port tubes 469 into one or more compressed air chambers 478. The magnets 485 at the end of the fixed magnetic core 483 opposite the piston magnet 480 are separated from each other. Alternatively, one or both of those standard magnets 485 may be split, each split magnet 485 having half the strength of the original magnet 485. Compressed air 475 or 445 may pass between the magnets 485 and produce a magnetic push on the piston magnet 480, the compressed air 475 or 445 remaining separate from the inert or other special gas 430 in the contraction chamber 465. Additionally, the magnet 485 sections may be shaped so that the compressed air 475 or 445 creates torque for increased magnetic push. The direction of the compressed air 475 or 445 and of its effects may be reversed.

The piston head 480 and other magnets 487 and 485 are not limited to the illustrated arrangement of FIG. 12 or FIG. 13 for utilizing compressed air 475 or 445 to act on the piston 410. Any number of less powerful magnets that maintain the equilibrium equation stated above may be used. Accordingly the number of spaces between magnets may vary. The magnets 480, 487 and 485 themselves may be special engineering shapes. The magnetic core 483 may have one or more holes (not shown), or none, along its length. Additionally, the compressed air 475 of 445 may act on similar parts constructed of materials other than magnets, such that the compressed air 475 or 445 may move a piston 410 without the presence of magnets 480, 487, or 485.

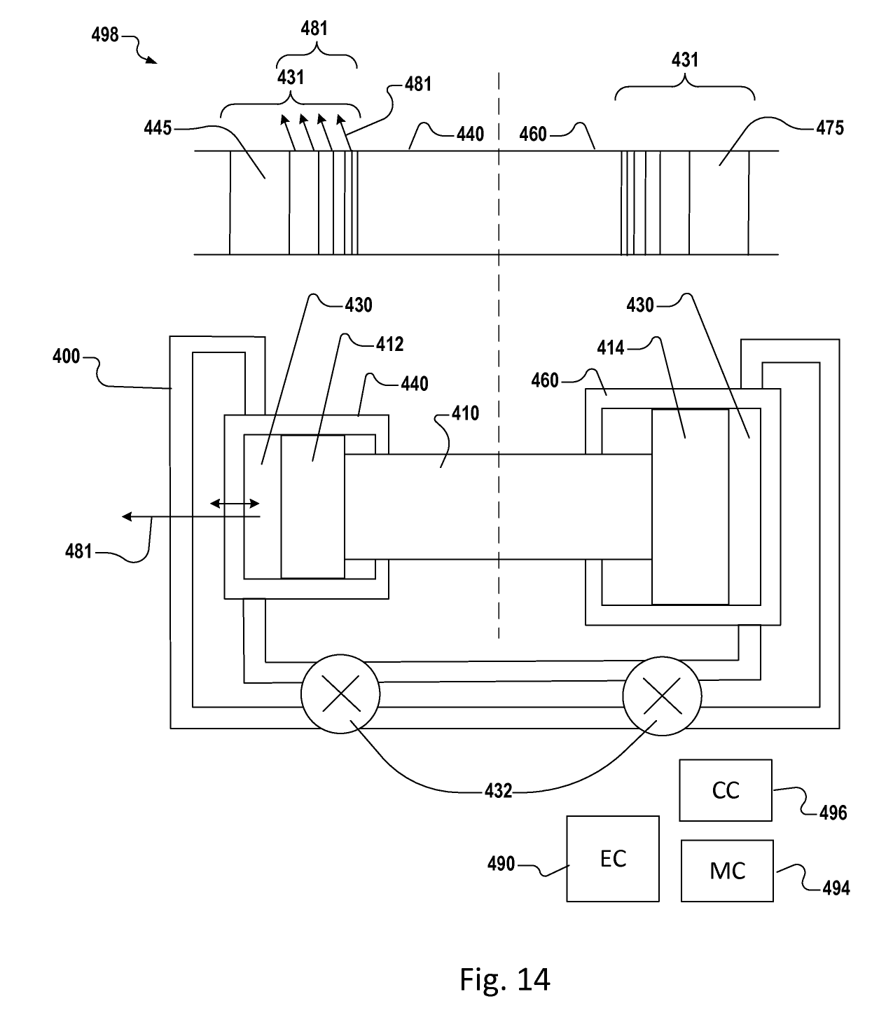

FIG. 14 is an illustration of a compressed air chart 498 and the additive magnetic “push” 481 that hot compressed air 475 or cold compressed air 445 provide to boost the push from the magnetic piston 414/480. The gas displacement measurements 431 shown in the chart depict that for the same pressure in the closed gas 430 loop, subsequent displacement 431 reduces. When the displacement 431 reduces, the magnetic push 480 kicks in, as indicated on the air chart 498 with upwards slanting arrows 481. The thermal electronic engine 400 of FIG. 7 is shown to aid the illustration. The hot chamber 440 is to the left, and cold compressed air 445 is introduced or injected to affect the temperature of the gas 430 in the hot chamber 440. The cold chamber 460 is to the right, and hot compressed air 475 is introduced or injected to affect the temperature of the gas 430 in the cold chamber 460 and the magnetism of the piston head 414. Thus, the compressed air 475 or 445 provides an added “push” 481.

In summary, the thermal electronic engine 400 may include the basic piston 410 motion controlled by thermal flow, an additional boost to piston 410 motion controlled by electromagnetic variation, and further boost and torque controlled by application of compressed air 475 or 445. All of these processes are controlled by an electronic controller 490. Separately and in combination, these functions improve upon engines previously manufactured. Proprietary software enables the electronic controller 490 to make the precise decisions necessary to run the thermal reaction electronic engine 400.

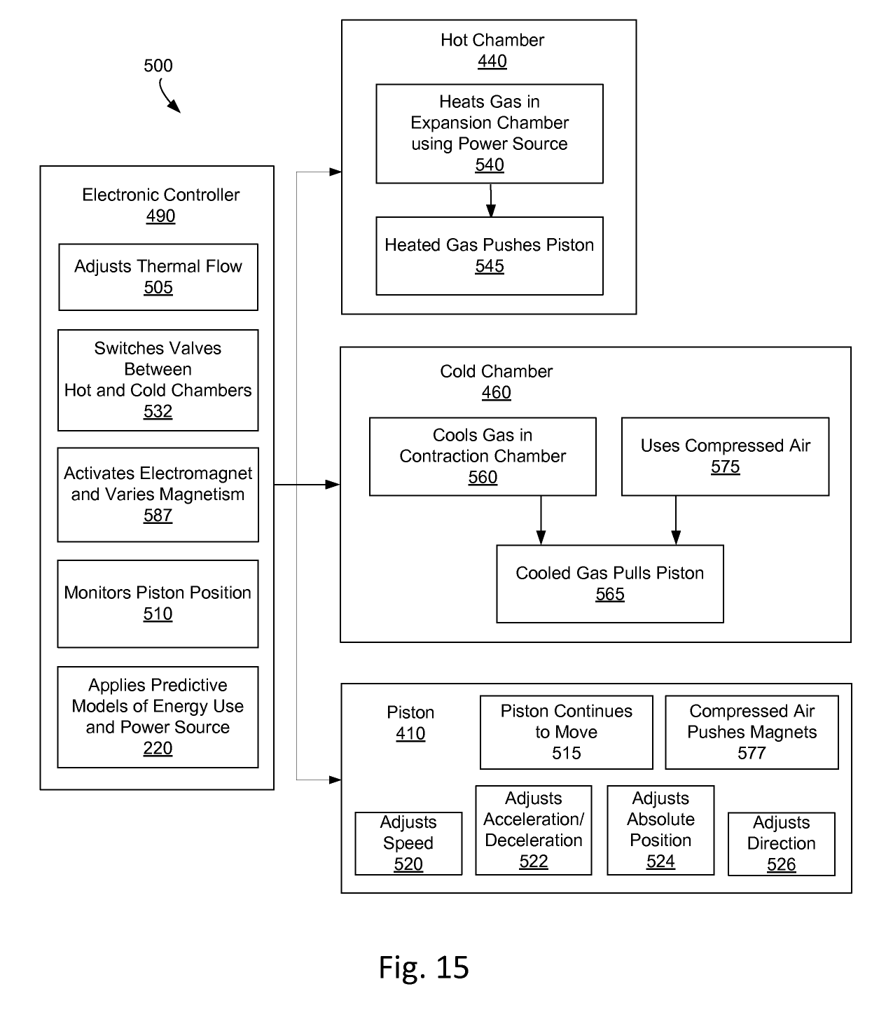

FIG. 15 is a flow chart that shows the method for controlling a thermal reaction electronic engine 500 of FIG. 11 with a few enhancements. The electronic controller 490 adjusts the thermal flow 505 throughout the whole engine 400 and monitors and influences the position of the piston 510 as part of the process. The electronic controller 490 heats the inert or other special gas in the expansion chamber 540 of the hot chamber 440 using at least one outside power source 103 (not shown), and the heated gas pushes the piston 545. The electronic controller 490 cools the gas in the contraction chamber 560 of the cold chamber 460, and the cooled gas pulls the piston 565. Compressed airflow may act on the cold chamber 575 creating a pressure difference and additional pull on the piston 410. A byproduct of the compressed airflow is a negative temperature. The electronic controller 490 switches valves to allow the gas to flow through the hot chamber and cold chamber 532 in the most efficient manner. Additionally, the electronic controller 490 may activate the electromagnet and vary its magnetism 587. Thus, the piston 410 moves. The electronic controller 490 may further influence the piston 410 by association of compressed air, engaging the piston with a push and torque effect 577. The electronic controller 490 adjusts speed 520, acceleration and deceleration 522, absolute position 524, and direction 526 of the piston 410. In this way, the electronic controller 490 displaces the piston 410. The process repeats at variable or constant speed, and the piston continues to move 515. The electronic controller 490 applies predictive models of energy use and of the power source 220 in order to learn and optimize engine 400 performance. In FIG. 15, many of the steps are optional, and the order of the steps may in many instances be re-arranged.

Persons reasonably skilled in the art will recognize that various changes may be made in the above details without departing from the spirit and scope of the thermal electronic engine as defined. The thermal electronic engine includes several independently meritorious inventive aspects and advantages. The first is a thermal electronic engine, the engine comprising: an electronic controller; at least one hot chamber in which a gas is heated by at least one outside power source; at least one cold chamber connected to the at least one hot chamber in a closed loop system; at least one piston; and at least two valves that control gas flow into and out of the at least one hot chamber and the at least one cold chamber; wherein the electronic controller opens and closes the at least two valves to regulate the flow of the gas through the valves, thus regulating the temperatures within the chambers; and wherein the gas flow moves the at least one piston. Further, the electronic controller may control the flow of at least one power source that produces heat. The at least one piston may act upon the crankshaft. The thermal electronic engine may also comprise at least one permanent magnet and at least one electromagnet, wherein at least one piston is magnetized and the strength and direction of the at least one electromagnet is varied to cause the at least one magnetized piston to move. Compressed air may act on the cold chamber to create a pressure difference that causes the at least one piston to move. Compressed air may push the piston. The thermal electronic engine may also comprise an encoder. One hot chamber and one cold chamber may comprise one cylinder of an engine.

The second of the independently meritorious inventive aspects and advantages of the TREE is a thermal electronic engine, the engine comprising: an electronic controller; at least one hot chamber in which a gas is heated by at least one outside power source; at least one cold chamber connected to the at least one hot chamber in a closed loop system; at least one magnetized piston positioned within the at least one cold chamber; at least one electromagnet positioned within the at least one cold chamber; and at least two valves that control gas flow into and out of the at least one hot chamber and the at least one cold chamber; wherein the electronic controller opens and closes the at least two valves to regulate the flow of the gas through the valves to move the at least one magnetized piston; and wherein the electronic controller varies the magnetism of the at least one electromagnet such that the at least one electromagnet affects the movement of the at least one magnetized piston. Further, the thermal electronic engine may comprise a contraction chamber internal to the at least one cold chamber. At least one magnetized piston may be a permanent magnet. Compressed air acting on the cold chamber may create a pressure difference that causes the at least one piston to move.

The third of the independently meritorious inventive aspects and advantages of the TREE is a method of producing motion with and controlling a thermal engine utilizing an electronic controller, the method comprising: engaging at least one outside power source; heating a gas within the thermal engine's hot chamber; switching valves to move gas through the thermal engine's hot chamber and cold chamber within a closed loop system, thus moving at least one piston; and monitoring the position of a piston as it moves between hot and cold chambers. Further, at least one electromagnet may be activated, positioned inside the thermal engine's cold chamber; and the magnetism of the at least one electromagnet may be varied to move the at least one piston; wherein the at least one piston is a magnetized piston. Compressed airflow may be applied to the cold chamber to cause a pressure difference that affects the movement of the at least one piston. The speed, acceleration, deceleration, absolute position, and direction of the at least one piston may be adjusted. Predictive models of energy use and of the at least one power source may be applied.

Demand-Based Starting and Charging

Described below are embodiments and configurations of systems and methods for demand-based starting and charging. Such systems and methods may comprise an electronic controller, a power source such as a generator, a capacitor bank, and a battery bank. The capacitor bank generally includes two or more supercapacitors that can charge and discharge at the same time, and also charge and discharge at different rates. The capacitor bank may work in tandem with a battery bank of rechargeable batteries. A power-consuming device benefits from the system and may be considered part of the system. In use, the power-consuming device demands power, and the electronic controller selectively engages individual supercapacitors within the capacitor bank to supply electricity to both the device and, on start-up, to partially torque a starter engine. The electronic controller maintains a balance of running the generator, charging the capacitor bank and the battery bank, and discharging the capacitor bank and the battery bank. Thus, the demand-based starting and charging system is instantaneous and efficient, and the charge and discharge curves are predictable and controllable. Many different embodiments and configurations are contemplated.

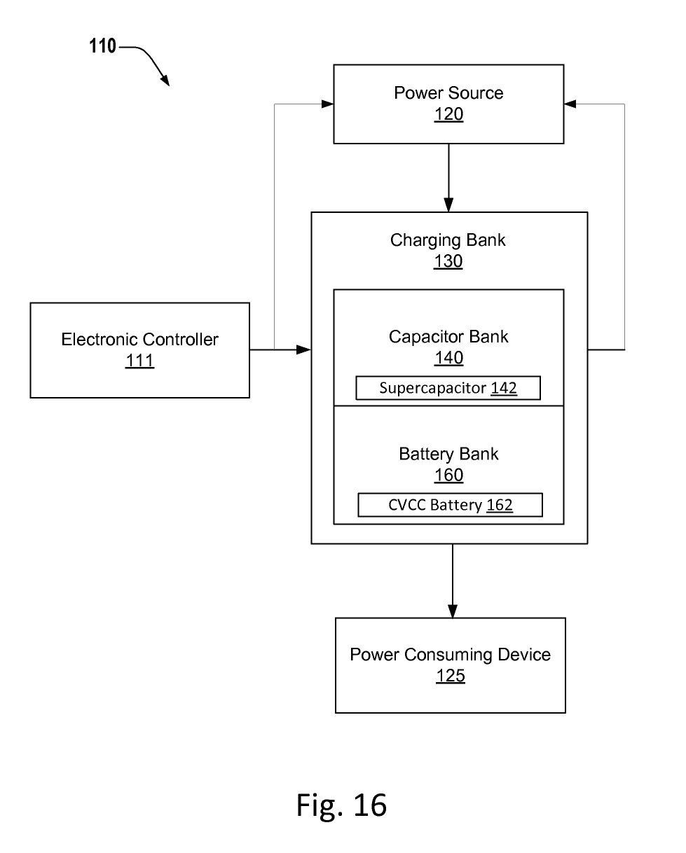

FIG. 16 illustrates one embodiment of a demand-based starting and charging system 110 in which an electronic controller 111 interfaces with a power source 120 and a charging bank 130 that may be comprised of a capacitor bank 140 and a battery bank 160. The capacitor bank 140 is an array of capacitors 142 and/or supercapacitors 142. Supercapacitors 142 and conventional capacitors differ from each other in that supercapacitors 142 have higher available capacitance and greater energy density; however, supercapacitors 142 may be familiarly called capacitors 142, as is the case in this application. Capacitors 142 and supercapacitors 142 may be engineered in varying ways, and this present invention is not limited to a particular composition or a current technology. The battery bank 160 will be described later.

The power source 120 may be a generator 120. Specifically, the power source 120 may be a thermal electronic engine 400 (not shown). The controller 111 is run by sophisticated software that employs artificial intelligence to monitor the operating environment, to learn patterns of power consumption, and to make instantaneous changes that optimize functionality. The power source 120, capacitor bank 140, and battery bank 160 may be of many varieties, sizes, and configurations, but they are configured to operate together and to the scale required by the electric power-consuming device 125 or devices. The electronic controller 111 selectively charges and discharges the individual supercapacitors 142 and batteries 162 within the charging bank 130.

The capacitor bank 140 serves two purposes at an initial call for power. First, the electronic controller 111 discharges current 242 from the capacitor bank 140 to meet the need of the power-consuming device 125. Simultaneously, the electronic controller 111 discharges current 242 from the capacitor bank 140 to start the generator 120 utilizing an alternator (not shown). The alternator may be a polyphase alternator 600, but this invention is not limited to a polyphase alternator. Because the need for initial power is met by the capacitor bank 140 discharge, the system goes from zero to around 30% or more power instantaneously, and the electronic controller 111 does not need to fully torque the engine 120. The system's intelligence allows it to run the generator 120 at partial and varying speed as needed to supply the power-consuming device 125, to charge the capacitor bank 140 and the battery bank 160, and to manage all power surge requirements. An electronic controller 111 may be a printed circuit board (“PCB”), a computer, or another suitable structure that includes circuitry and logic for executing control functions.

The demand-based starting and charging system 110 is not limited to one power source 120. Rather, multiple power sources 120 may be managed by the electronic controller 111 to allow the capacitor bank 140 to charge at different rates at different times. For example, solar power 120 may charge the supercapacitors 142 in the capacitor bank 140 at one rate during daylight, and gas 120 may be burned to charge the supercapacitors 142 in the capacitor bank 140 at a different rate during the night.

Current industry practice is to torque an engine 120 to full speed 25 at a call for power, and for the engine 120 to continue running at full speed until the call for power ends, whether the power required is a few watts to power one device 125 or many watts to power many devices 125. Such use is hard on the engine 120 and wastes valuable energy. The charging bank 130, on the other hand, continues to provide power, as needed, even when the engine 120 is not running 228.

The capacitor bank 140 may be considered a fast-charging battery in which each cell is a capacitor 142 or battery 142. The capacitor bank 140 may work in conjunction with a battery bank 160 of normal, slow-charging batteries 162 such as NiCd or NiCd/Lithium Ion batteries 162. Normal batteries 162 of any make may be utilized with the system 110 provided they meet the system 110 requirements. Intelligent charging is required to manage the give-and-take of concurrent fast and slow charging, as well as the variation in charge rates.

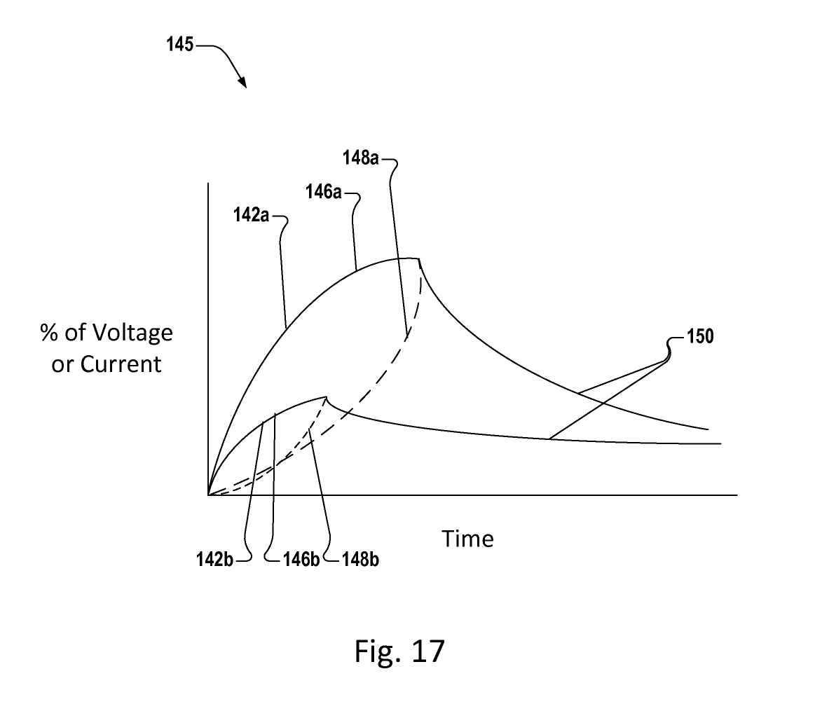

FIG. 17 is an illustrative embodiment of the charge and discharge curves 145 of at least two supercapacitors 142 (142a and 142b) layered in a capacitor bank 140. The invention is not limited to a specific number of supercapacitors 142. As shown, each supercapacitor 142 may charge in at least two different ways, depending upon direction from the electronic controller 111—fast charge (solid line) 146a and 146b or trickle charge (dashed line) 148a and 148b. The electronic controller 111 learns patterns of power use and makes decisions based on time of day, types of power sources 120 available, and energy demanded, among other criteria. Likewise, the supercapacitors 142 in the capacitor bank 140 discharge at different rates. In general, the more steady the discharge curve 150, the more linear or simple the charging curve 146 or 148. The charge curves 146 or 148 and discharge curves 150 of the supercapacitors 142 in the capacitor bank 140 are predictable and controllable.

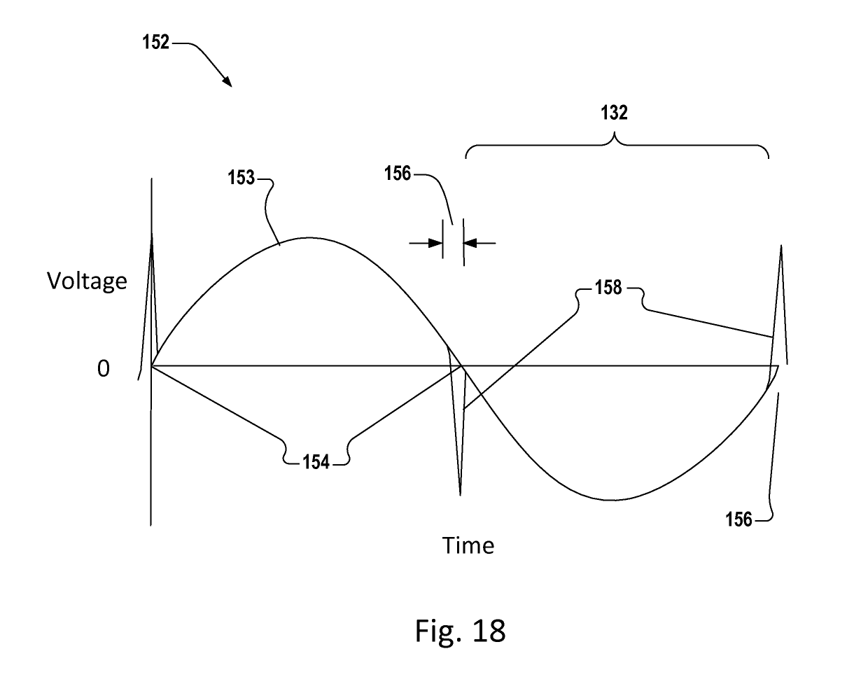

FIG. 18 illustrates typical supercapacitor charging curves 152 related to the use of controlled spikes 158 for charging supercapacitors 142 in the capacitor bank 140. The generator 120 produces power 132 with a sine wave 153. As the generator 120 produces power 132 and the voltage reaches zero 154, the electronic controller 111 treats that axis crossing 154 as a charging area 156. At that time, the electronic controller 111 rapidly charges a supercapacitor 142 by creating a high voltage spike 158 having a carefully controlled width.

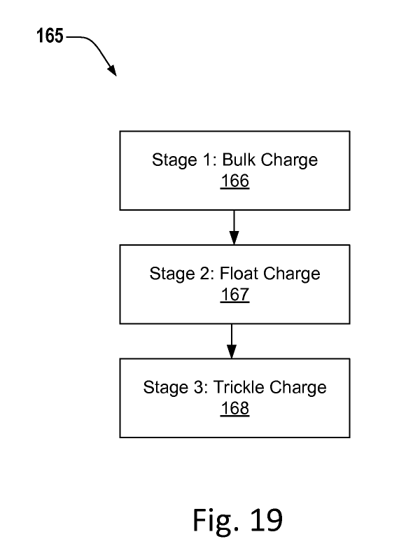

FIG. 19 illustrates the stages 165 of recharging a battery bank 160 comprised of constant-voltage/constant-current (“CVCC”) batteries 162. The first stage is the bulk charge 166, a relatively quick charging of CVCC batteries 162 in which the batteries 162 are charged at a constant rate until the cell 162 voltage reaches a preset value. Stage two is a float charge 167 wherein the batteries 162 are held at a constant voltage below the battery's 162 upper voltage limit. Then stage three is a trickle charge 168 that is a slow, continuous charge designed to allow flexibility in the demand-based starting and charging system 110 and to compensate for self-discharge of the batteries 162. Certain of the charging stages 165 are not suitable for all brands of batteries 162.

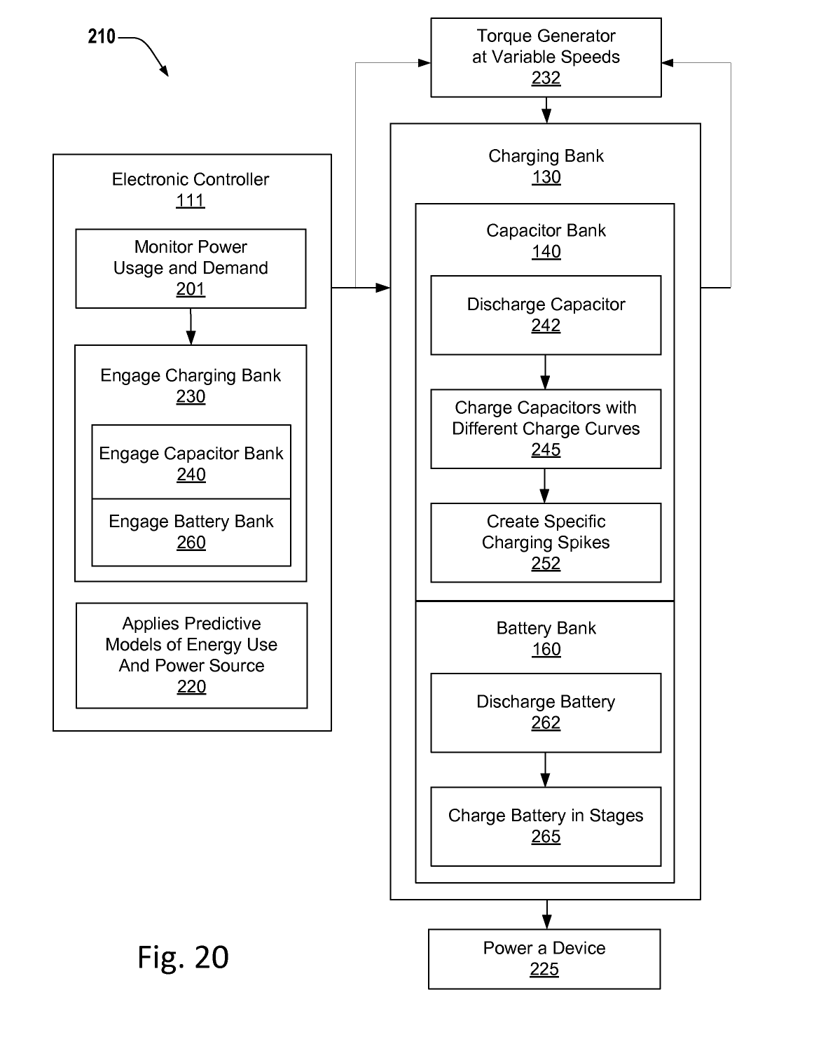

FIG. 20 is a flow chart of a method of demand-based starting and charging 210. The electronic controller 111 monitors power usage and demand 201 and, at a call for power, engages a charging bank 230, thus engaging a capacitor bank 240 and/or engaging a battery bank 260. The electronic controller 111 simultaneously discharges power from one or more supercapacitors 242 having different discharge curves within the capacitor bank 140 to power a power-consuming device 225 and to start and run a generator 232 with an alternator (not shown). The electronic controller 111 torques the engine 232 partially and at variable speeds to generate power 132. During power generation 132, the electronic controller 111 directs the charging of supercapacitors 245 having different charge curves within the capacitor bank 140. For instantaneous charging, the electronic controller 111 creates specific high voltage spikes 252 for specific supercapacitors 142. Each supercapacitor 142 may charge 245 and discharge 242 at the same time, or at different times, and each supercapacitor 142 has a charge curve and a discharge curve 145 that is predictable and controllable. Likewise, the electronic controller 111 may discharge batteries 262 in the battery bank 160, to augment the capacitor bank 140, and charge the batteries in stages 265. The electronic controller applies predictive models of energy use and of the power source 220. Thus, the demand-based starting and charging method 210 is both instantaneous and efficient. In FIG. 20, some of the steps are optional, and the order of the steps may in many instances be re-arranged.

Persons reasonably skilled in the art will recognize that various changes may be made in the above details without departing from the spirit and scope of the thermal electronic engine as defined. The thermal electronic engine includes several independently meritorious inventive aspects and advantages. The first is a demand-based starting and charging system for powering a device, comprising: a capacitor bank comprising two or more capacitors; and an electronic controller that interfaces with a power source and the capacitor bank; wherein the electronic controller selectively charges the two or more capacitors with power from the power source and selectively discharges the two or more capacitors to deliver power to a power-consuming device. The electronic controller may utilize artificial intelligence to learn patterns of power consumption and of power sources. The electronic controller may selectively charge each capacitor with a different charge curve. The capacitor bank may contain capacitors with varying charge curves and discharge curves. The system may further comprise capacitor charging spikes. A capacitor charging spike may occur when the sine wave of generated power reaches a voltage of zero. One capacitor in the capacitor bank may charge and discharge at the same time. The capacitor bank may work in tandem with standard rechargeable batteries. The power source may be a generator.

The second of the independently meritorious inventive aspects and advantages of the demand-based starting and charging system is an intelligent capacitor bank, comprising: a capacitor bank comprising two or more supercapacitors with various charge curves and discharge curves; and an electronic controller that interfaces with the capacitor bank; wherein the electronic controller applies predictive models of energy use and power use, selectively charges the two or more capacitors with power from a power source, and selectively discharges the two or more capacitors to deliver power to a power-consuming device.

The third of the independently meritorious inventive aspects and advantages of the demand-based starting and charging system is a method for on-demand starting and charging with an electronic controller in order to meet the demands of a power-consuming device, the method comprising: charging two or more capacitors within a capacitor bank; discharging one or more capacitors at a call for power; starting and running a power source that recharges the capacitors; and creating charging spikes for one or more capacitors whenever the power generation sine curve reaches a voltage of zero. The system may further comprise charging and discharging a slow-charging battery bank. A generator may be the power source. Different capacitors charge and discharge at different rates. At a call for power a discharge from the capacitor bank may instantly provide 30% or more power to the power-consuming device. The power consumed may selectively inform the one or more capacitors to be utilized. The generator may start at less than full torque. The generator may run intermittently and at less than full speed. The electronic controller may utilize artificial intelligence to learn patterns of power consumption. One capacitor may charge and discharge at the same time.

Polyphase Alternator

Described below are embodiments and configurations of a polyphase alternator and methods for controlling the polyphase alternator. Such device and methods may comprise an electronic controller, at least one permanent magnet assembly that may be a rotor, one or more winding arrays that may be stators, each containing an array of conductive coils, and a drive shaft. In use, the electronic controller causes the drive shaft to turn at least one rotor around one or more stators in a radial motion. The coils of the polyphase alternator may be individually positively or negatively charged in order to affect an engine. An electronic controller allows the polyphase alternator to fulfill three functions. First, the polyphase alternator acts as a charger for a supercapacitor to start an engine and eliminate cogging. Second, the polyphase alternator functions as a generator itself. Third, the polyphase alternator acts as a high voltage charger. Thus, the polyphase alternator is ultra-efficient and produces variable speed and variable frequency. A digital system produces the desired output, independent of the speed of the generator. Many different embodiments and configurations are contemplated.

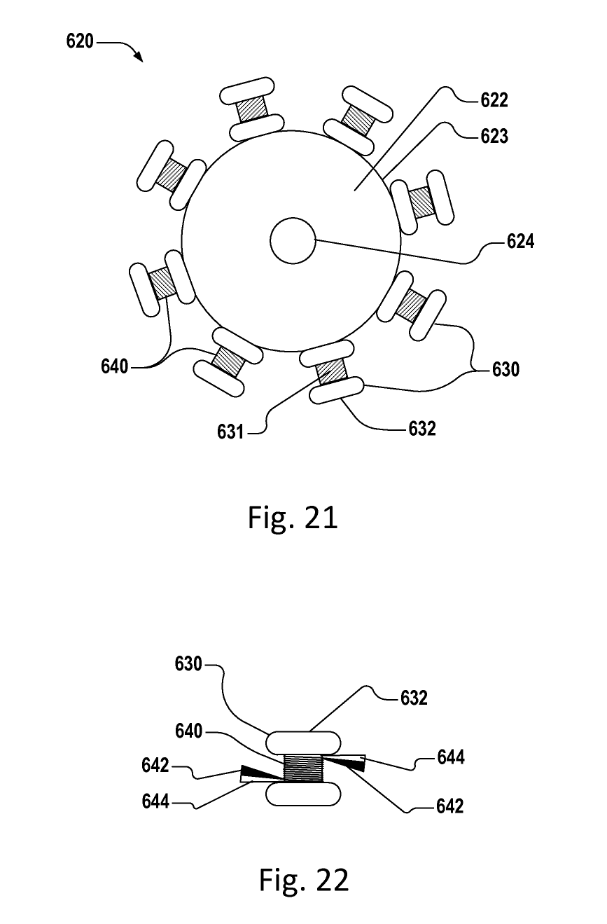

FIG. 21 is a front view of a winding array 620. In a preferred embodiment the winding array 620 is a stator array 620. A disc 622 having a substantially circular shape and an aperture 624 in the center, through which a drive shaft 686 (not shown) may pass, is mounted on its edge 623 by an array of eight or more winding cores 630 that are equally spaced around the disc 622 and apart from one another. The core 630 may have a substantially flat face 632 that may be generally perpendicular to a post portion 631, and the core face 632 and post 631 may be made from any suitable ferromagnetic material, such as iron or mild steel. At least one conductive wire 640, which may be copper, and preferably two or more, is wound around the post 631 of each winding core 630, the ends of the wire 640 connected in a specific manner to allow individual management by an electronic controller 610. The number of conductive coils 630 is not limited to eight, but may be few or many conductive coils 630, and the spacing of the array of conductive coils 630 may vary for different configurations. “Coil” and “winding” may be used interchangeably, as may certain references to “wire.” A winding array 620 of conducting coils 630 may also be called a “coil” 620. A winding array 620 is not limited to being a stator, but may be configured as a rotor with the addition of a brush to conduct current.

The disc 622 may be composed of any material, including metal, plastic, or any alloy or composite, and may be of any shape and size that supports the functionality of this invention. In a preferred embodiment, the winding cores 630 are shaped like spools or barbells, but the winding cores 630 are not limited to that particular shape.

Typical industry practice is for a conductive coil 640 to be wound in one direction around a winding core post 631. The angle and direction of the winding 640 are crucial to alternator performance, as is the RPM achieved by the rotor moving in relationship to the stator.

FIG. 22 is an illustrative front view of a winding core 630. In a preferred embodiment of the present invention, the winding 640 is preferably a bifilar winding 640, meaning there are at least two types of wire 640 per coil 630. A first wire 642 is wound in one direction, and a second wire 644 is wound in the opposite direction to produce a dynamic arrangement. The second wire 644 forms a transient coil 640b, the function of which will be described later, whose ends have charges opposite to the matching ends of the first wire 642. It is envisioned that the second wire 644 may be smaller in diameter than the first wire 642 and that the winding 640b of the second wire 644 may require fewer turns than the winding 640a of the first wire 642. This invention is not limited to two wires 640 per coil 630; rather, a winding core or coil 630 may contain more than two wires 640. Additionally, the wires 640 are not limited to particular diameters or makes, and the wires 640 may have insulating coatings.

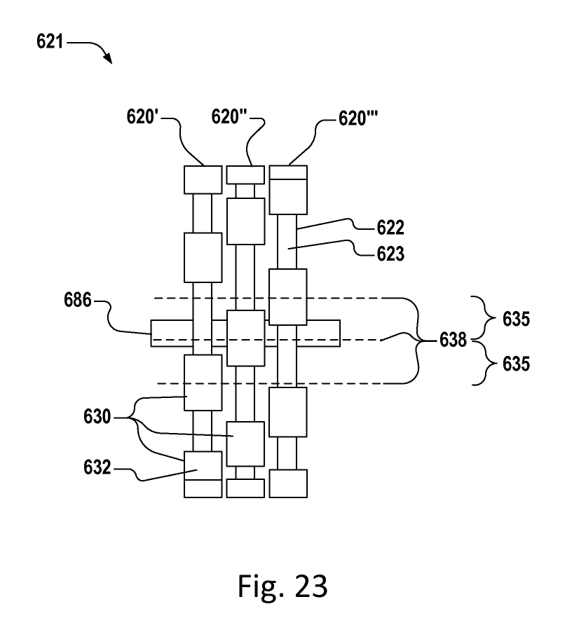

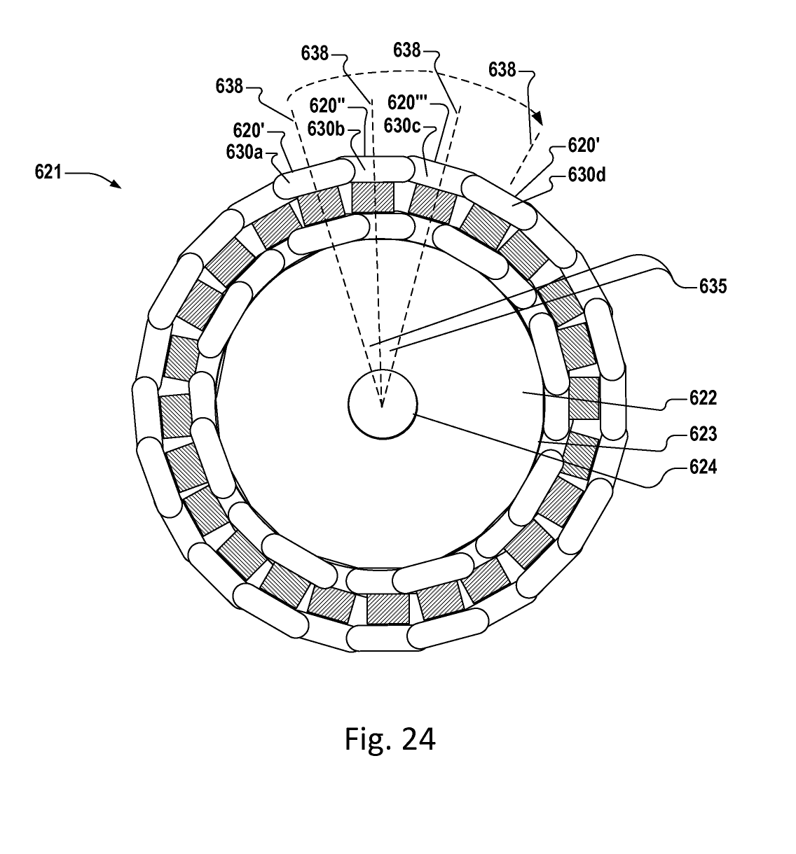

FIGS. 23 and 24 describe a set 621 of three of the winding arrays 620 (noted as 620′, 620″, and 620′″). FIG. 23 is an illustrative side view of the three winding arrays 621. Winding cores 630 are mounted on the edge 623 of a disc 622. Only the outer face 632 of the “nearest” winding cores 630 are shown, and any winding cores or coils 630 behind those are omitted for simplicity. Core centers 638 indicated by dashed lines in FIGS. 23 and 24 show the staggered relationship, or radial offset 635, between conductive coils 630 that eliminates cogging or jumping as a permanent magnet rotor 680 (not shown) turns on the drive shaft 686 around such a set of stators 621.

FIG. 24 is a front view of a set of three winding arrays 621. A second winding array 620″ is radially offset 635 from the first winding array 620′ by one-third of the distance between the centers 638 of two neighboring winding cores 630 on the first winding array 620′. A third winding array 620′ is radially offset 635 from the first winding array 620′ by two-thirds of the distance between the centers 638 of two neighboring winding cores 630 on the first winding array 620′. The dashed lines illustrate this relationship, as the first 630a, second 630b, and third 630c marked conductive coils 630 reside on the first 620′, second 620″, and third 620′″ winding arrays, respectively. The fourth marked conductive coil 630d is a neighboring winding 630 of the first conductive coil 630a on the first winding array 620′. The winding arrays 620 are parallel to one another and compose a set or stage 621. The present invention is not limited to three winding arrays 620 or to one set of winding arrays 621.

In a preferred embodiment, each winding array 620 in a set of three winding arrays 621 is wired with a different voltage wire 640. The difference in wiring 640 allows each winding array 620 to perform a different function, yet all three winding arrays 620 may work together. The invention is not limited to each winding array 620 being wired differently, as certain winding arrays 620 and/or individual windings 630 may be of similar voltage wire 640 as designed for a specific device.

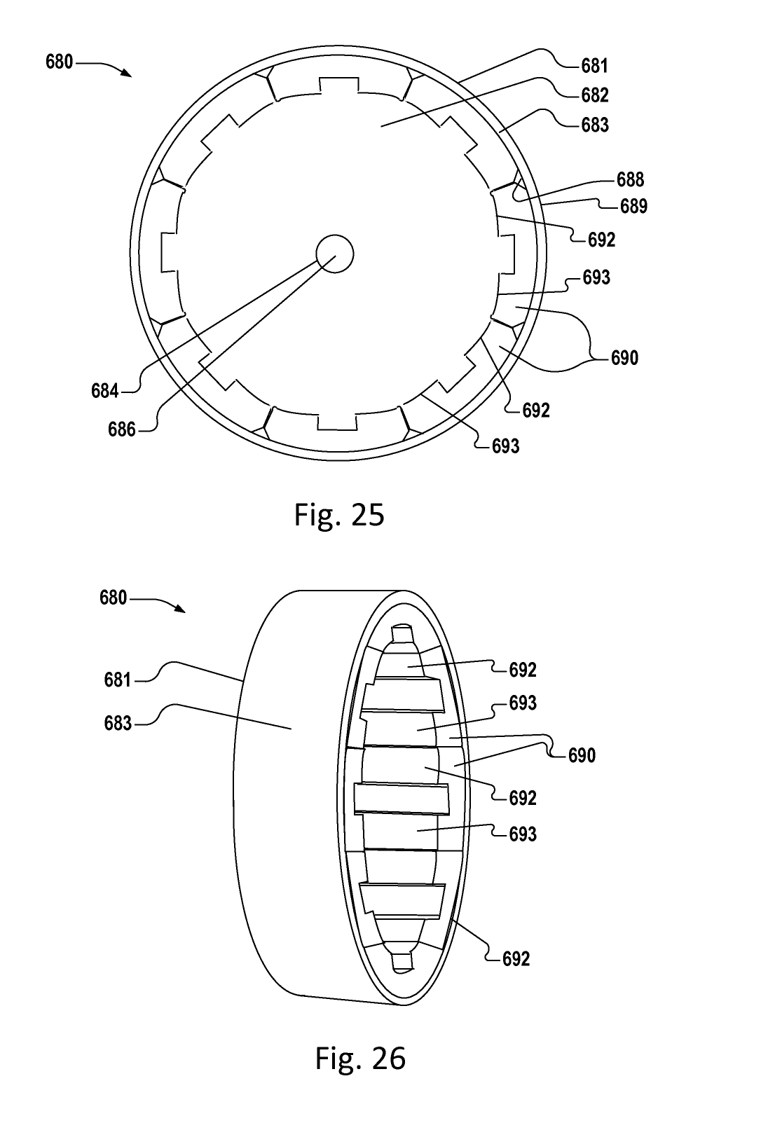

FIG. 25 is a front view of a permanent magnet assembly 680, and FIG. 26 is a perspective view of the same permanent magnet assembly 680. In a preferred embodiment, the permanent magnet assembly 680 is a rotor magnet assembly 680. A circular chamber 681 has a chamber wall 683 and a chamber end plate 682, the end plate 682 and the wall 683 intersecting to form the chamber 681. Permanent magnets 690 are mounted on the inner surface 688 of the chamber wall 683, their pole faces 692 and 693 pointing toward the center of the chamber 681, and are radially spaced apart from each other around the perimeter of the inner surface 688. In a preferred embodiment, eight permanent magnets 690 are relatively close to each other, each magnet 690 having a north (N) pole face 692 and a south (S) pole face 693, arranged in an N-S-N-S repeating pattern. The chamber 681 and permanent magnets 690 are wide enough to cover a set of three winding arrays 621. The magnets 690 may be secured to the inner surface 688 of the chamber wall 683 using any suitable adhesive, preferably a high temperature adhesive, or via other means of attachment that does not interfere with magnetic properties and product performance. An aperture 684 is centered in the chamber's end plate 682, and means are provided to allow rotation by a drive shaft 686. The invention is not limited to eight magnets 690, the close spacing, or the shape of the chamber 681 or magnets 690 as shown. Magnets 690 may be of any strength required and may be composed of any functional material, including, but not limited to, neodymium, neodymium alloys, and graphite alloys. The method of magnetization determines the angle of magnetization and biasing. The invention is also not limited to one permanent magnet assembly 680, a drive shaft 686 being able to turn multiple magnet rotor assemblies 680 in simultaneous and synchronous fashion. Further the magnets 690 are not limited to positioning on the inner surface 688 of the chamber wall 683, but may be positioned on the outer surface 689 of the chamber wall 683. Such permanent magnets or electromagnets 690 are extremely strong and dangerous and necessitate careful handling.

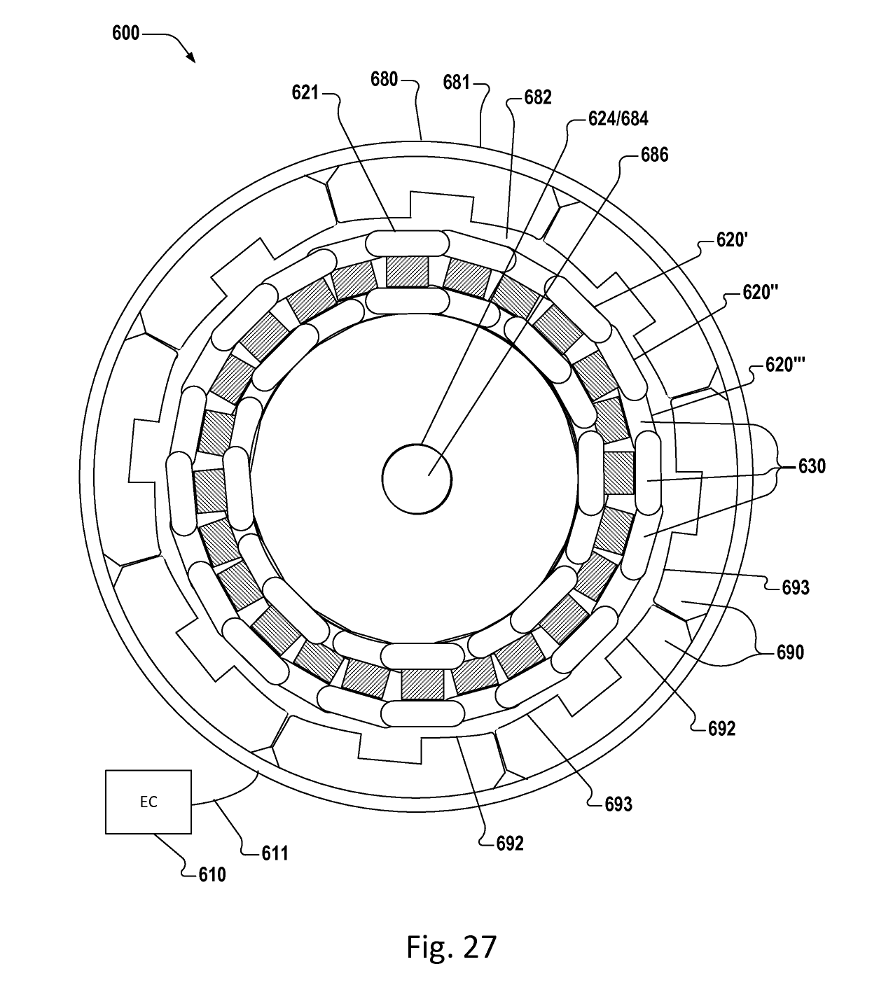

FIG. 27 is a front view of the key parts of a polyphase alternator 600 according to the present invention. A set 621 of three winding arrays 620 (620′, 620″, and 620′″) is positioned within a permanent magnet assembly 680. In a preferred embodiment, the winding arrays 620 are stator arrays 620 and the permanent magnet assembly 680 is a rotor magnet assembly 680. Wiring details are omitted for the sake of clarity, but an electronic controller 610 is wired 611 to individually control a drive shaft 686 and each of the individual conductive coils 630 on each of the three stator arrays 620. An electronic controller 610 may be a printed circuit board (“PCB”), a computer, or another suitable structure that includes circuitry and logic for executing control functions. A drive shaft 686 may turn the rotor magnet assembly 680 about the set of stator arrays 621, causing a magnetic field to pass over the conductor coils 630. Advanced software running the electronic controller 610 may neutralize, or turn off, individual stator arrays 620 and/or individual conductive coils 630 as needed to affect an engine (not shown). The engine may be a thermal electronic engine 400, but the polyphase alternator may function with other engines as well.

It is further envisioned that other configurations may be employed wherein the permanent magnet assembly 680 is a stator and the winding arrays 620 of conductive coils 630 are rotors. Such configurations are common to typical alternators. Additionally, the permanent magnets 690 may point outward, away from the circular chamber 681 center, should the winding array 620 be arranged around the permanent magnet assembly 680. In some embodiments electro-magnets may also or alternatively be substituted for at least some of the permanent magnets 690.

The polyphase alternator 600 housing or casing (not shown), winding array disc 622, core post 631, core face 632, circular chamber end plate 682, chamber wall 683, drive shaft 686, and other parts may be formed of materials including, but not limited to, polypropylene, aluminum, ABS, ABS+, polylactic acid, mild steel, acetal. Lightweight, high strength materials are preferred, but other materials may also meet the performance requirements.

FIG. 18, previously discussed related to the demand-based starting and charging system 110, also applies to the polyphase alternator 600 as an illustration of a supercapacitor charging curve 152 according to the present invention and enabled by the transient wire 644 of the bifilar winding 640 described earlier. As the generator 120 is running, the sine wave 153 above and below zero shows when torque is being generated. Where the sine wave 153 crosses zero voltage 154, there is no torque (this is neutral), and a charging spike 158 is required. This zero crossing 154 is a charging area 156 of carefully controlled width managed by an electronic controller 610. The transient wire 644 provides dynamic shifting in that it causes high voltage spikes 158 when the voltage crosses zero 154 and induces power when the permanent magnet rotor assembly 680 changes direction. It is envisioned that each stator winding array 620 and/or individual conductive coils 630 may act as supercapacitors, depending upon the required device functionality. The polyphase alternator 600 acts like a charger for a supercapacitor and as a generator at the same time. Supercapacitors need spiked voltage 158. The transient wire 644 hits a supercapacitor 142 with these spiked charges 158 many times, and the capacitor 142 has a tendency to grab and hold a charge.

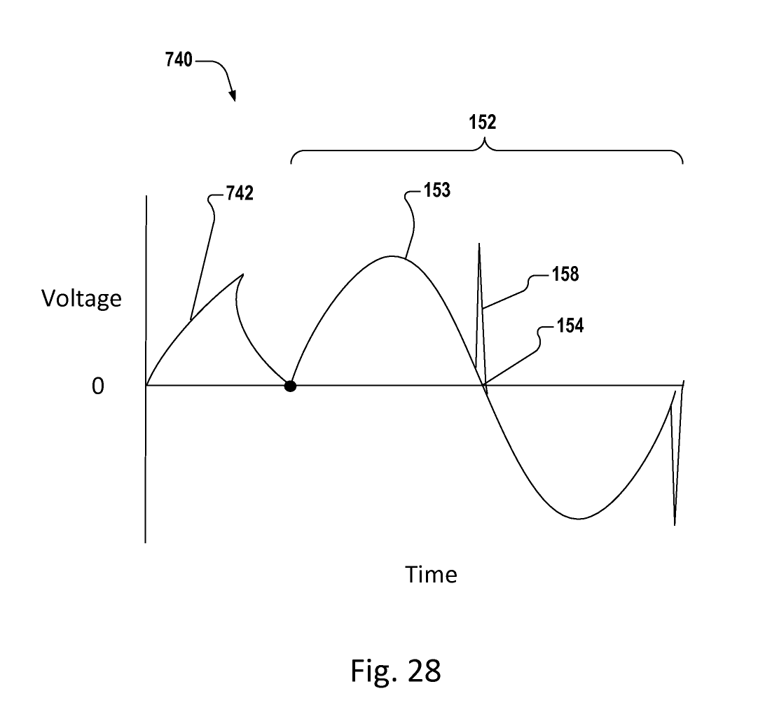

FIG. 28 is an illustration of a polyphase alternator's 600 starting and charging curves 740. Just as no engine is able to start by itself, an alternating current generator has to be started. The present invention provides instantaneous starting by an electronic controller 610 powering a first stator winding array 620′ (also called a disc or coil) to start an engine 120. The first illustrated wave is a first strong discharge 742 from Winding Array 1 (620′). A second stator winding array 620″ is started, and generator-like power flows with a sine wave 153 from Winding Array 2 (620″). As described with the transient wire 644, Winding Array 1 (620′) provides charging spikes 158 when the voltage crosses zero 154. A third stator winding array 620′ engages in both slow and instant charging. The three winding arrays 620 may be put in neutral, individually or together. This arrangement acts as a multi-coil generator able to vary speed (RPM) and run at partial or full power. During motor operation, eddy current effects are neutralized by electronic switching and dynamic software. The three winding arrays 620 may be numbered and connected in any sequence within the set 621. The polyphase alternator 600 is not limited to one set 621 of winding arrays 620.

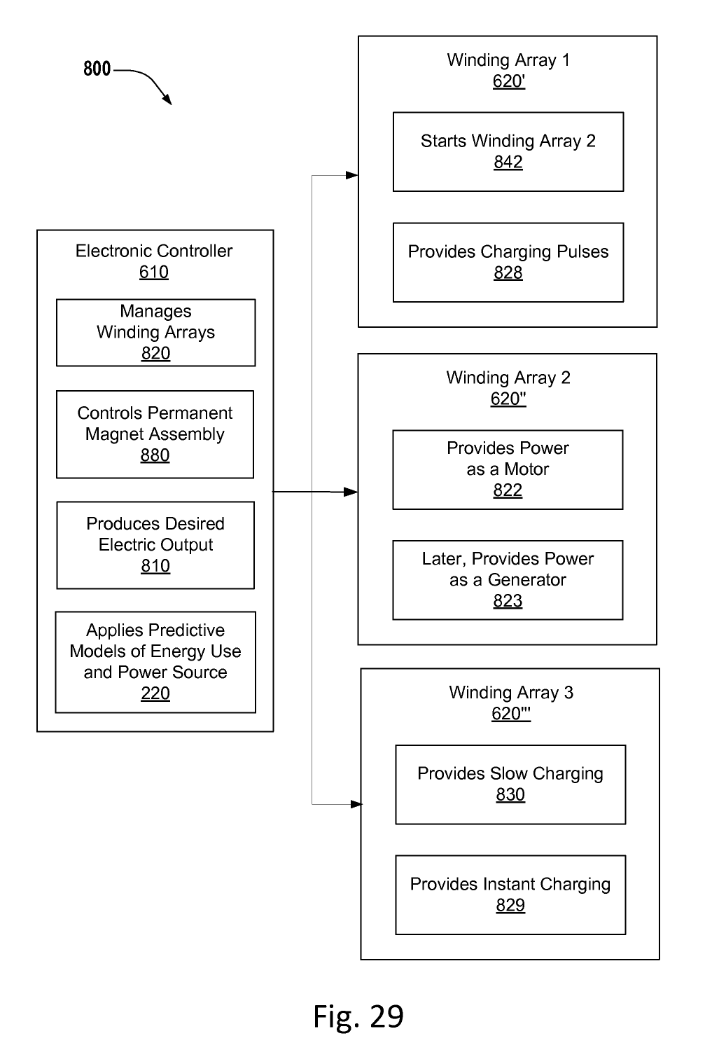

FIG. 29 is a flow chart illustration of a method of controlling a polyphase alternator 800 of the present invention. In use an electronic controller 610 controls, one rotating around the other, a permanent magnet assembly 880 and a set of three winding arrays 820, the electronic controller 610 managing the winding arrays 820 by individually varying the electrical conductance of each winding array 620 and each conductive coil 630 on the winding arrays 620. At a call for power, the polyphase alternator 600 initially functions as an alternator plus motor. The electronic controller 610 powers a first winding array 620′ that acts as a charger for a supercapacitor and gives an instant charge to start 842 a second winding array 620″ that acts as a motor 822. A third winding array 620′ is engaged in both slow charging 830 and instant charging 829. The first winding array 620′ and third winding array 620′″ may deliver charging spikes 828 and 829 when the voltage output crosses zero 154. When the first winding array 620′ is neutral, the second winding array 620″ and third winding array 620′″ dictate the generator RPM. When the first winding array 620′ and third winding array 620′″ are both neutral, the second winding array 620″ brings the generator to the desired RPM 823. At the desired RPM, the second winding array 620″ may cut off, and the first winding array 620′ and third winding array 620′″ may maintain the RPM. The electronic controller 610 dynamically and swiftly assures speed control, frequency control, and peak control.

The polyphase alternator 600 traps the variable frequency to convert to DC using a permanent magnet and rectifiers (not shown), which may be three-phase bridge rectifiers and may include electronic filters, and uses a digital system to produce the desired electric output 810, independent of the speed of the generator. Additionally, the mechanical speed of the generator will be altered electronically to produce high voltage pulses 158 on select phases to charge an instantaneous storage and charging system 110. The polyphase alternator 600, which may be familiarly referred to as a “polyalt” 600, is a reliable design that is difficult to damage electrically. In FIG. 29, some of the steps are optional, and the order of the steps may in many instances be re-arranged.

Persons reasonably skilled in the art will recognize that various changes may be made in the above details without departing from the spirit and scope of the thermal electronic engine as defined. The thermal electronic engine includes several independently meritorious inventive aspects and advantages. The first is a polyphase alternator comprising: an electronic controller; at least one magnet assembly; one or more winding arrays each having an array of conductive coils; and at least one drive shaft that causes the at least one permanent magnet assembly and the one or more winding arrays to move relative to each other in a radial motion; wherein the electronic controller varies the conductivity, charging, and discharging of the winding arrays and conductive coils, individually or collectively, to produce variable speed. The magnet assembly may be a permanent magnet assembly. The magnet assembly may be an electromagnet assembly. The conductive coils on a winding array may be equally spaced around and mounted to the edge of a circular disc; and wherein each winding array in the set is parallel to each other winding array in the set. At least one conductive coil may comprise bifilar wire. The bifilar wire may contain a transient wire that produces charging spikes when the alternator voltage equals zero.

The second of the independently meritorious inventive aspects and advantages of the polyphase alternator is a polyphase alternator comprising: an electronic controller; at least one magnet rotor; a drive shaft that turns the at least one magnet rotor; and at least one set of stators, each having an array of conductive coils; wherein the at least one magnet rotor rotates relative to the at least one set of stators; and wherein the electronic controller varies the conductivity, charging, and discharging of individual stators and of individual conductive coils on the stators to produce variable speed. At least two stators may be wired with different types of wire. A stator may act as a charger for a supercapacitor. A stator may act as a motor or generator. A stator may provide slow charging and instant charging for supercapacitors and batteries. Variable speed produces variable frequency, and the electronic controller may produce constant desired output independent of the speed of the alternator. At least one conductive coil may comprise bifilar wire. The bifilar wire may comprise a first wire wound in one direction and a second wire wound in the opposite direction. A first stator may start a second stator. One or more stators provide charging spikes to another stator. Charging spikes may be provided when the alternator voltage equals zero.

The third of the independently meritorious inventive aspects and advantages of the polyphase alternator is a method for electronically controlling a polyphase alternator, the method comprising: managing the relationship of radial motion of a magnetic assembly and a paired set of winding arrays of conductive coils, one moving around the other; and charging one or more conductive coils on one winding array with high-voltage pulses from one or more conductive coils located on a different winding array. The method may further comprise starting one winding array with another winding array, running the polyphase alternator as a generator, providing both slow charging and instant charging, enabling speed, frequency, and peak control through control of the radial motion, and/or digitally producing desired output independent of generator speed.

Conclusion

The digital power plant systems 100 and methods for operating a digital power plant 200 lead to many “green” power benefits. The digital power plant 100 produces a pure, smooth sine wave 153 and a continuous kW rating with a near unity power factor. Onsite, power may be configured for desired frequency/hertz, voltage, and single-phase, 2-phase, or 3-phase output—as well as for multiple energy sources 103. The digital power plant 100 ensures load balancing and overload protection, plus the key components are designed for long life. Together with the artificial intelligence electronic controller 101, an installed digital power plant 100 does not need to be touched by human hands unless it breaks. Power is produced on-demand around the clock 228.

Although the foregoing specific details describe various embodiments and configurations of the invention, persons reasonably skilled in the art will recognize that various changes may be made in the details of the apparatus of this invention without departing from the spirit and scope of the invention as defined in the appended claims.

The present invention includes several independently meritorious inventive aspects and advantages. Unless compelled by the claim language itself, the claims should not be construed to be limited to any particular set of drawings, as it is contemplated that each of the drawings may incorporate features shown in others of the drawings.

I claim:

1. A digital system that generates electricity for at least one power-consuming device, the system comprising:
an electronic controller; and
an electronic engine comprising at least two chambers, a closed loop system for carrying a gas between the at least two chambers, the gas entering and leaving the chambers through valves, and at least one piston head in at least one of the chambers;
wherein the electronic controller controls the flow of the gas through the valves, the gas moving the at least one piston head, and the resultant flow of electricity output by the electronic engine.

2. The digital system of claim 1, wherein the electronic engine is a thermal engine.

3. The system of claim 2, wherein the thermal engine may interface with at least two external power sources.

4. The digital system of claim 1, further comprising a demand-based starting and charging system that comprises a capacitor bank of two or more capacitors selectively charged and discharged by the electronic controller.

5. The system of claim 4, wherein the electronic controller starts another component of the digital system with a discharge from the demand-based starting and charging system.

6. The digital system of claim 1, wherein the at least one piston head is magnetic.

7. The digital system of claim 1, wherein the electronic controller applies predictive models of energy use and of a power source.

8. An electric generator, comprising:
an electronic controller;
a thermal electronic engine; and
a capacitor bank comprising two or more supercapacitors;
wherein the electronic controller manages the thermal electronic engine and the capacitor bank to produce electricity.

9. The electric generator of claim 8, wherein the electronic controller applies predictive models of at least one power source and of energy use.

10. The electric generator of claim 8, wherein the electricity has a pure sine wave and a continuous kW rating.

11. The electric generator of claim 8, wherein the generator is configured onsite for the desired frequency, voltage, and phase.

12. The electric generator of claim 8, wherein the listed parts are a kit to connect onsite.

13. A method for generating electricity for at least one power-consuming device, the method comprising:
activating an electronic controller;
discharging electricity from a capacitor bank;
running an electronic engine;
recharging capacitors in the capacitor bank; and
repeating the steps of discharging and charging capacitors in a capacitor bank;
the electronic controller varying the flow of power during each step to optimize the flow of electricity to the at least one power-consuming device.

14. The method of claim 13, wherein the electronic engine is a thermal electronic engine.

15. The method of claim 13, wherein the capacitor bank comprises at least two capacitors that charge and discharge at different rates, the method further comprising determining which capacitor or capacitors to charge or to discharge.

16. The method of claim 13, wherein the electronic controller selectively charges a capacitor or capacitors with a high voltage pulse.

17. The method of claim 13, further comprising running the engine intermittently and at partial speed.

18. The method of claim 13, wherein the capacitor bank works in tandem with standard rechargeable batteries.

19. The method of claim 13, further comprising employing a polyphase alternator to start the electronic engine.

20. The method of claim 13, wherein the electronic controller utilizes artificial intelligence to learn patterns of power consumption and power supply.
